(19) United States
(12) Patent Application Publication
(10) Pub. No.: US 2026/0110364 A1
(43) Pub. Date: Apr. 23, 2026

(54) FLUID VALVE ASSEMBLY FOR A SEAT

(71) Applicant: Lear Corporation, Southfield, MI (US)

(72) Inventors: Olivier Cabrit, Munich (DE); Anders Groenhage, Mullsjoe (SE); Frank Dankbaar, Tidaholm (SE)

(73) Assignee: Lear Corporation, Southfield, MI (US)

(21) Appl. No.: 19/283,669

(22) Filed: Jul. 29, 2025

(30) Foreign Application Priority Data
Oct. 21, 2024 (DE) 10 2024 130 542.8

(51) Int. Cl. F16K 7/17; B60N 2/66; B60N 2/70

(52) U.S. Cl. CPC F16K 7/17; B60N 2/7088; B60N 2/665; F16K 2200/402

(57) ABSTRACT

A fluid valve assembly for a seat comprising a fluid bladder, the fluid valve assembly comprising: a valve housing at least partially defining a first fluid inlet, a first fluid outlet, and a first exhaust outlet; a diaphragm disposed at least partially in the valve housing and configured to flex between a first position and a second position according to a first fluid pressure difference between the first fluid inlet and the first fluid outlet.

### CROSS-REFERENCE TO RELATED APPLICATIONS

This application claims the benefit of and priority to German Patent Application 10 2024 130 542.8, filed Oct. 21, 2024, the disclosure of which is hereby incorporated by reference in its entirety as though fully set forth herein.

### TECHNICAL FIELD

The present disclosure generally relates to fluid valve assemblies, including fluid valve assemblies that can, for example, be utilized in connection with vehicle seats.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic side view generally illustrating an embodiment of a seat assembly including a valve assembly according to teachings of the present disclosure.

FIG. 2 is a perspective view generally illustrating an embodiment of a valve assembly according to teachings of the present disclosure.

FIG. 3 is a cross-sectional perspective view generally illustrating the embodiment of a valve assembly, taken along line III-III of FIG. 2 with a diaphragm body in a default position, according to teachings of the present disclosure.

FIG. 4 is a cross-sectional view generally illustrating the embodiment of a valve assembly of FIG. 3, with the diaphragm body in an extended position, according to teachings of the present disclosure.

FIGS. 5 and 6 are perspective views generally illustrating an embodiment of a diaphragm according to teachings of the present disclosure.

FIG. 7 is a cross-sectional perspective view generally illustrating an embodiment of a valve assembly according to teachings of the present disclosure.

FIGS. 8 and 9 are cross-sectional views generally illustrating an embodiment of a diaphragm according to teachings of the present disclosure.

FIG. 10 is a perspective view generally illustrating an embodiment of a valve assembly according to teachings of the present disclosure.

FIG. 11 is a cross-sectional perspective view generally illustrating an embodiment of a valve assembly according to teachings of the present disclosure.

FIG. 12 is a perspective view generally illustrating an embodiment of a diaphragm according to teachings of the present disclosure.

FIG. 13 is a perspective view generally illustrating an embodiment of a valve assembly according to teachings of the present disclosure.

FIG. 14 is an exploded perspective view generally illustrating an embodiment of a valve assembly according to teachings of the present disclosure.

FIG. 15 is a perspective view generally illustrating an embodiment of a diaphragm according to teachings of the present disclosure.

FIG. 16 is a perspective view generally illustrating an embodiment of a second housing member according to teachings of the present disclosure.

FIG. 17 is a cross-sectional perspective view generally illustrating an embodiment of a valve assembly according to teachings of the present disclosure.

FIG. 18 is a cross-sectional perspective view generally illustrating portions of the embodiment of the valve assembly of FIG. 17.

FIGS. 19-21 are cross-sectional views generally illustrating an embodiment of a valve assembly according to teachings of the present disclosure.

FIGS. 22 and 23 are cross-sectional views generally illustrating an embodiment of a valve assembly according to teachings of the present disclosure.

FIG. 24 is an exploded perspective view generally illustrating an embodiment of a valve assembly according to teachings of the present disclosure.

FIGS. 25 and 26 are cross-sectional views generally illustrating an embodiment of a valve assembly according to teachings of the present disclosure.

FIGS. 27 and 28 are cross-sectional views generally illustrating an embodiment of a valve assembly according to teachings of the present disclosure.

FIG. 29 is a perspective view generally illustrating an embodiment of a diaphragm according to teachings of the present disclosure.

FIGS. 30 and 31 are cross-sectional views generally illustrating an embodiment of a valve assembly according to teachings of the present disclosure.

FIG. 32 is a perspective view generally illustrating an embodiment of a diaphragm according to teachings of the present disclosure.

FIG. 33 is a cross-sectional perspective view generally illustrating an embodiment of a diaphragm according to teachings of the present disclosure.

FIG. 34 is a perspective view generally illustrating an embodiment of a diaphragm according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

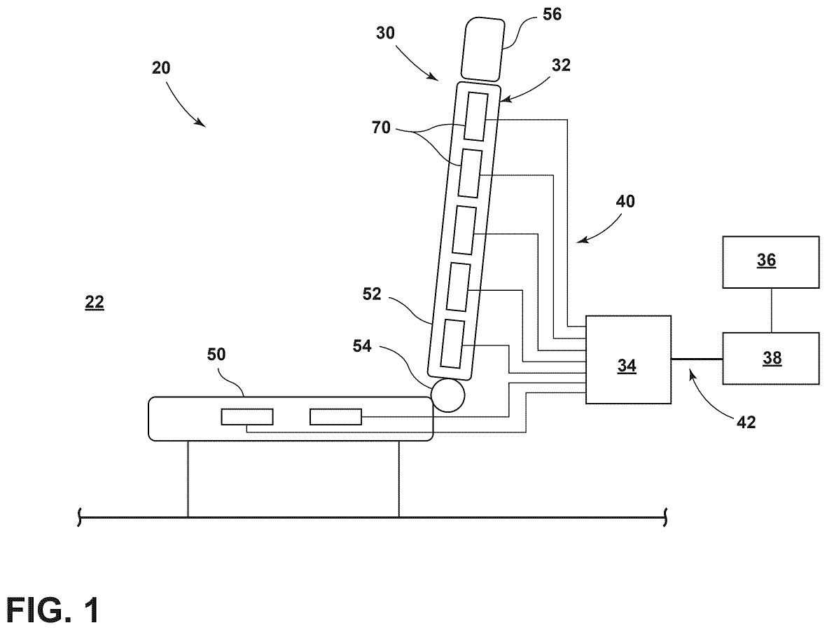

Referring to FIG. 1, a seat assembly 20 is illustrated in a vehicle 22 and includes a seat 30, a bladder assembly 32 (e.g., a fluid bladder assembly), a valve assembly 34 (e.g., a fluid valve assembly), and an electronic controller 36. The valve assembly 34 is fluidly coupled with a fluid source 38. The valve assembly 34 at least partially controls the flow of fluid (e.g., air) from the fluid source 38 to inflate the bladder assembly 32 and the flow of fluid out of the bladder assembly 32 for deflation of the bladder assembly 32. The valve assembly 34 is, for example, fluidly coupled with the bladder assembly 32 via one or more fluid conduits 40 (e.g., pipes, tubes, hoses, passages, manifolds, among others). The seat 30 includes a seat base 50 and a seat back 52 coupled (e.g., rotatably coupled) with the seat base 50, such as via a recliner 54. The seat back 52 is illustrated with a headrest 56. The bladder assembly 32 includes one or more fluid bladders 70 disposed at least partially in the seat 30, such as in one or both of the seat base 50 or the seat back 52. The fluid source 38 is configured to output a flow of fluid (e.g., air) to the valve assembly 34, such as via one of more fluid conduits 42 (e.g., pipes, tubes, hoses, passages, manifolds, among others). The fluid source 38, for example, includes one or more of a pump, a compressor, a tank fluidly coupled to an external fluid source, or a source valve assembly fluidly coupled with the external fluid source. The electronic controller 36 is configured to control, at least in part, operation of the fluid source 38, such as in response to input from an occupant of the seat 30 (e.g., for massage, lumbar support, bolster or other adjustments, among others).

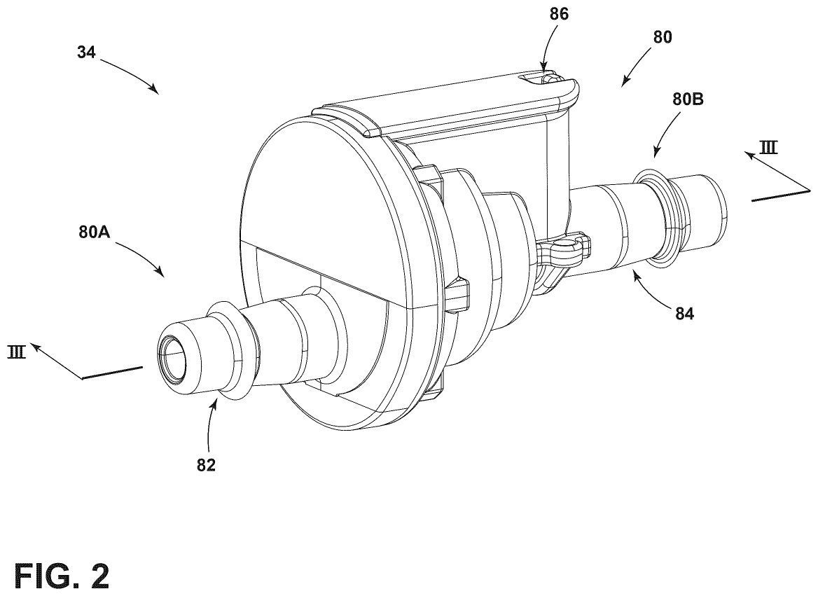

Referring to FIG. 2, a valve housing 80 of the valve assembly 34 is illustrated. The valve housing 80 at least partially defines a fluid inlet 82, a fluid outlet 84, and a exhaust outlet 86. The fluid inlet 82 is configured for fluidly coupling with the fluid source 38 (FIG. 1), such as via the one or more fluid conduits 42. The fluid outlet 84 is configured for fluidly coupled with one or more bladders 70 of the bladder assembly 32 (FIG. 1). The exhaust outlet 86 is fluidly coupled with ambient air. The valve housing 80 includes a first end 80A and a second end 80B. The fluid inlet 82 is disposed at the first end 80A. The fluid outlet 84 is disposed at the second end 80B.

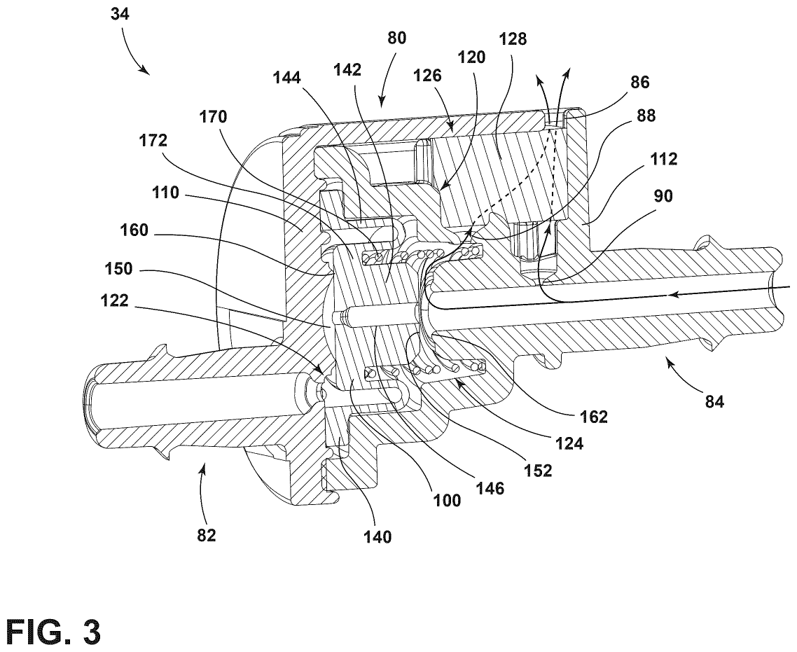

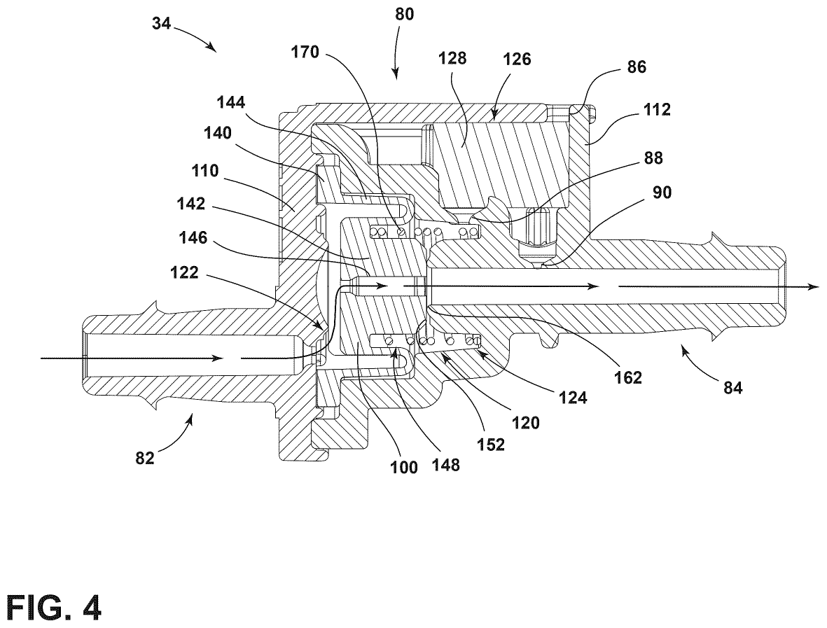

Referring to FIGS. 3 and 4, cross-sectional views of the valve assembly 34 including the valve housing 80 and a diaphragm 100 disposed at least partially in the valve housing 80. The valve housing 80 defines an exhaust port 88 and a bleed port 90 that are fluidly coupled with the exhaust outlet 86. The valve housing 80 is shown with a first housing member 110 and a second housing member 112 that cooperate to define a fluid chamber 120. The diaphragm 100 is disposed at least partially in the fluid chamber 120 and separates the fluid chamber 120 into a first section 122 and a second section 124. The exhaust port 88 is fluidly coupled with the second section 124 and fluidly couples the second section 124 with the exhaust outlet 86, at least with the diaphragm 100 in a position other than the second position. The bleed port 90 is fluidly coupled directly with the fluid outlet 84. For example, the fluid outlet 84 includes a cylindrical configuration and the bleed port 90 is disposed at a middle section of the fluid outlet 84.

The first housing member 110 and the second housing member 112 define an exhaust chamber 126 that fluidly couples the exhaust port 88 and the bleed port 90 with the exhaust outlet 86. A dampener 128 is optionally disposed in the exhaust chamber 126 at least partially between the exhaust port 88 and the exhaust outlet 86 and/or at least partially between the bleed port 90 and the exhaust outlet 86, such as to limit sound generated by fluid flowing out of the exhaust port 88 and/or the bleed port 90.

The diaphragm 100 is configured to flex between a first position, such as shown in FIG. 3, and a second position, such as shown in FIG. 4. In the first position, the diaphragm 100 restricts fluid flow from the fluid inlet 82 to the fluid outlet 84. In the second position, the diaphragm 100 permits fluid flow from the fluid inlet 82 to the fluid outlet 84 and restricts fluid flow from the fluid outlet 84 to the exhaust outlet 86. For example, in the second position, the diaphragm 100 at least partially blocks flow from the fluid outlet 84 (e.g., during deflation) into the second section 124 of the fluid chamber 120, which at least partially blocks a flow path from the fluid outlet 84 through the second section 124 and the exhaust port 88 to the exhaust chamber 126 and the exhaust outlet 86. The diaphragm 100 flexes between the first position and the second position according to a fluid pressure differential across the diaphragm 100, such as a fluid pressure difference between a first fluid pressure at the fluid inlet 82 and a second fluid pressure at the fluid outlet 84.

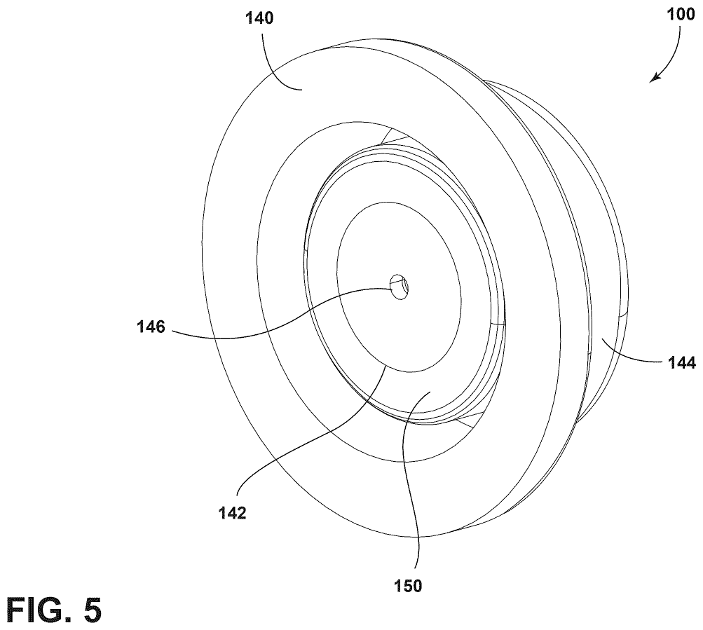

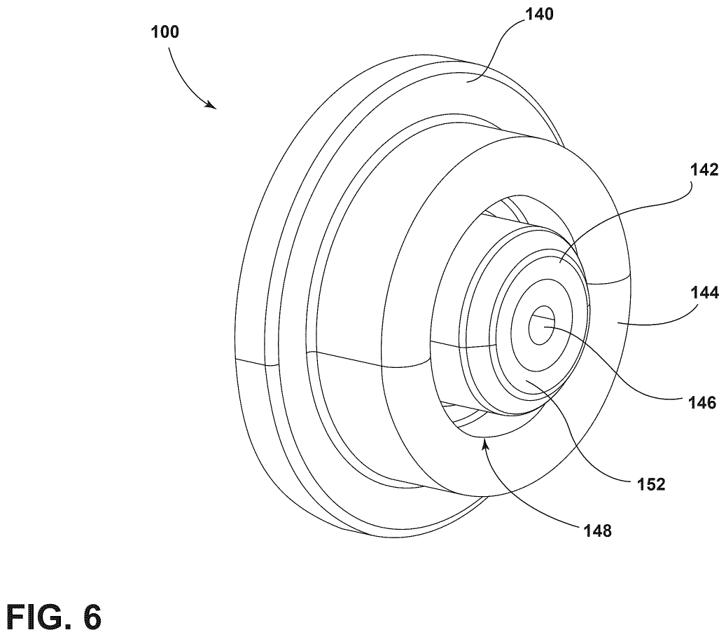

Referring to FIGS. 5 and 6, the diaphragm 100 includes a flange 140, a body 142, and a flexible arm 144 extending between and connecting the flange and the body 142. The flange 140 is fixedly coupled with the valve housing 80 (FIG. 3). For example, the flange 140 is clamped between portions of the first housing member 110 and the second housing member 112 (FIG. 3) such that the flange 140 does not move as the diaphragm 100 flexes between the first position and the second position. In the illustrated example, the diaphragm 100 includes a circular configuration with the flange 140 including an annular configuration and the body 142 including a cylindrical configuration. Optionally, the diaphragm 100 includes non-circular configurations, such as an elliptical configuration, or a non-uniform shape with curvature to allow for the diaphragm to flex between first and second positions. The body 142 defines a through aperture 146 extending therethrough. The flexible arm 144 includes a folded configuration that provides a U-shaped cross-sectional shape that opens away from the fluid outlet 84 (FIG. 3). Portions of the body 142 and the flexible arm 144 are spaced in a radial direction relative to a centerline of the body 142 through the through aperture 146 such that the diaphragm 100 defines a channel 148 (FIG. 6) that opens toward the second end 80B (FIG. 3). The body 142 includes a first body surface 150 (FIG. 5) and a second body surface 152 (FIG. 6) parallel with and opposite from the first body surface 150. The first body surface 150 faces the first end 80A (FIG. 3). The second body surface 152 faces the second end 80B (FIG. 3).

Referring again to FIG. 3, the valve housing 80 includes a first contact surface 160 and a second contact surface 162. The first housing member 110 includes the first contact surface 160. The second housing member 112 includes the second contact surface 162. The first contact surface 160 comprises, for example, an annular protrusion extending toward the second end 80B. The second contact surface 162 is provided at an inner end of the fluid outlet 84 and faces toward the first end 80A. In the first position of the diaphragm 100, the first body surface 150 is in contact with the first contact surface 160 such that fluid flow through the through the diaphragm 100 (e.g., through the through aperture 146) and/or between the first section 122 and the second section 124 or the fluid outlet 84 is restricted and/or prevented. In the second position of the diaphragm 100 illustrated in FIG. 4, the second body surface 152 is in contact with the second contact surface 162 such that fluid flow into the second section 124, such as from the fluid inlet 82 (e.g., during inflation) and from the first fluid outlet (e.g., for deflation) is restricted and/or prevented. Optionally, the valve assembly 34 includes a spring 170 is disposed in the second section 124 and biases the diaphragm 100 toward the first position. In the illustrated example, the spring 170 includes a coil spring that is disposed at least partially around the body 142 and at least partially in the channel 148. For example, the spring 170 applies a spring force to a base 172 of the body 142 toward the first end 80A such that the diaphragm 100 is biased toward the first position. Additionally or alternatively, the diaphragm 100 (e.g., the flexible arm 144) is prestressed to bias the diaphragm 100 toward the first position.

The diaphragm 100 moves from the first position to or toward the second position when the first fluid pressure at the fluid inlet 82 (e.g. in the first section 122) is exceeds a threshold that is sufficiently higher than the second fluid pressure at the fluid outlet 84 (e.g., in the second section 124) to overcome the spring force of the spring 170 and/or prestress forces of the flexible arm 144. For example, when the fluid source 38 (FIG. 3) provides fluid to the fluid inlet 82, the first fluid pressure builds in the first section 122 and overcomes the forces of the spring 170 and/or the prestress of the flexible arm 144. The diaphragm 100 moves to or toward the first position when the first fluid pressure drops below the threshold, such as when the fluid source 38 (FIG. 1) stops providing fluid to the fluid inlet 82.

The bleed port 90 is configured to allow fluid to flow from the fluid outlet 84 (e.g., from one or more bladders 70 fluidly coupled thereto) to the exhaust outlet 86, independent of the position of the diaphragm 100. For example, the bleed port 90 is fluidly coupled with fluid outlet 84 in all positions of the diaphragm 100, including the second position in which the diaphragm 100 restricts or prevents flow from the fluid outlet 84 into (e.g., directly) the second section 124. The fluid flow through the bleed port 90 facilitates reducing the fluid pressure at the fluid outlet 84 while the body 142 is in the extended position to reduce the differential pressure across the body 142 and facilitate movement of the body 142 toward the default position in which a greater amount of flow from the fluid outlet 84 to the exhaust outlet 86 is permitted (e.g., faster deflation). Such a bleed port configuration allows the one or more bladders 70 to deflate passively and may be referred to as a permanent deflation configuration. For example, the valve assembly 34 allows the one or more bladders 70 to deflate when the fluid source 38 is not providing fluid to the fluid inlet 82 and without actively removing fluid from the one or more bladders 70 (e.g., without applying a vacuum to the fluid inlet 82) or actively fluidly coupling the one or more bladders 70 with ambient air. Such passive deflation can allow for a less complex, lighter weight, more compact, and/or lower power consumption design.

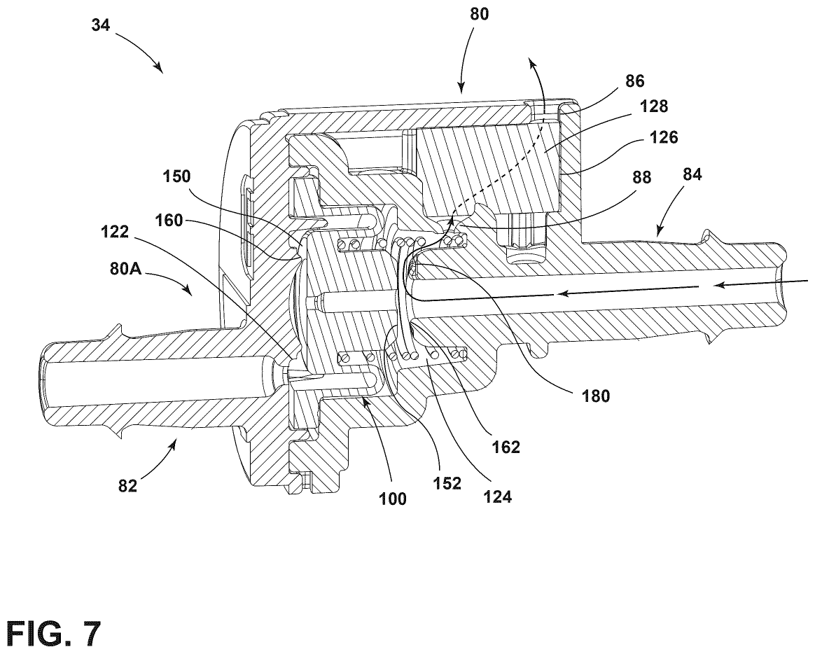

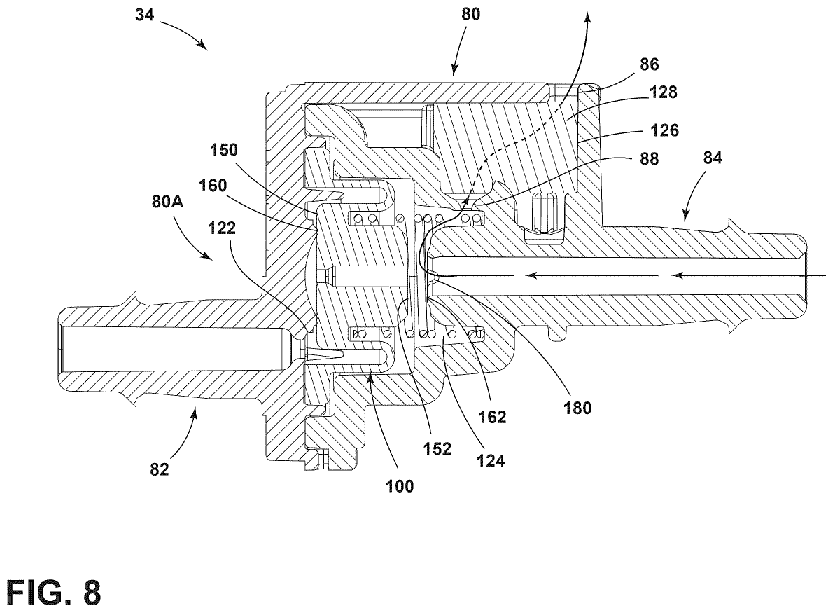

Referring to FIGS. 7-9, the valve housing 80 optionally includes a bleed channel 180, such as instead of or in addition to the bleed port 90 (FIGS. 3 and 4). The second contact surface 162 at least partially defines the bleed channel 180. For example, the second contact surface 162 is provided as an annular protrusion extending toward the first end 80A, and the bleed channel 180 is provided as a radially extending recess in the second contact surface 162. In the first position of the diaphragm (FIGS. 7 and 8), the body 142 is spaced from the contact surface 162 and fluid can flow through the fluid outlet 84 into the second section 124 via the bleed channel 180 and a gap between the second body surface 152 and the second contact surface 162, through the second section 124, through the exhaust port 88, through the exhaust chamber 126, and out of the valve housing 80 through the exhaust outlet 86 for deflation. In another example, the bleed channel 180 is provided via increased surface roughness of the second contact surface 162 and/or the second body surface 152.

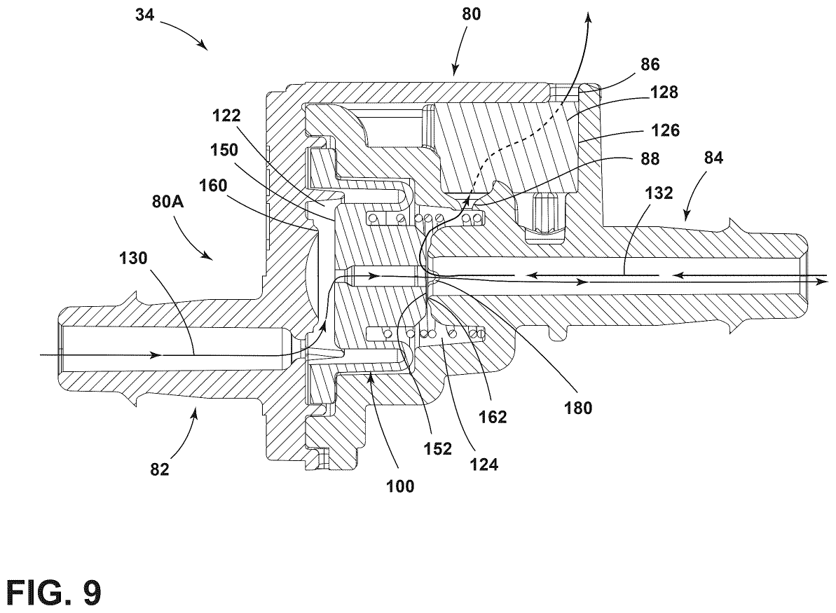

In the second position of the diaphragm 100 (FIG. 9), the second body surface 152 is in contact with some or most of the second contact surface 162, but is offset from the surface of the bleed channel 180 such that the fluid outlet 84 is fluidly coupled with the second section 124. The bleed channel 180 fluidly couples the fluid outlet 84 with the exhaust outlet 86 via the second section 124, the exhaust port 88, and the exhaust chamber 126. For example, with the body 142 in the extended position, fluid, represented by arrow 130, can flow from the fluid inlet 82 through the body 142 and through the fluid outlet 84 for inflation, or fluid, represented by arrow 132, can flow from the fluid outlet 84 through the bleed channel 180 through the second section 124, through the exhaust port 88, through the exhaust chamber 126, and out of the valve housing 80 through the exhaust outlet 86 for deflation. The bleed channel 180, for example, facilitates reducing the fluid pressure at the fluid outlet 84 while the body 142 is in the extended position to reduce the differential pressure across the body 142 and facilitate movement of the body 142 toward the default position, such as to provide automatic and passive deflation (e.g., permanent deflation).

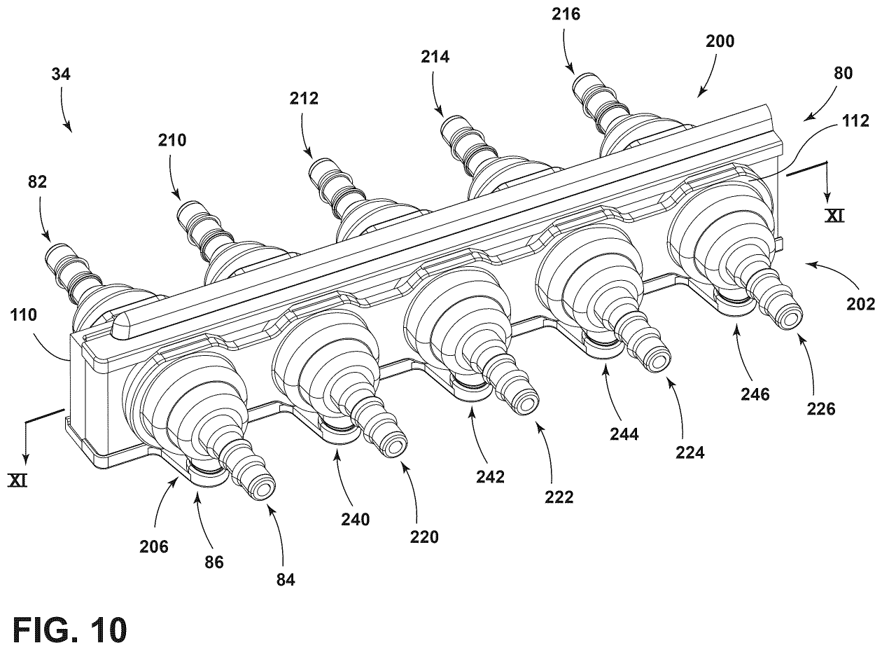

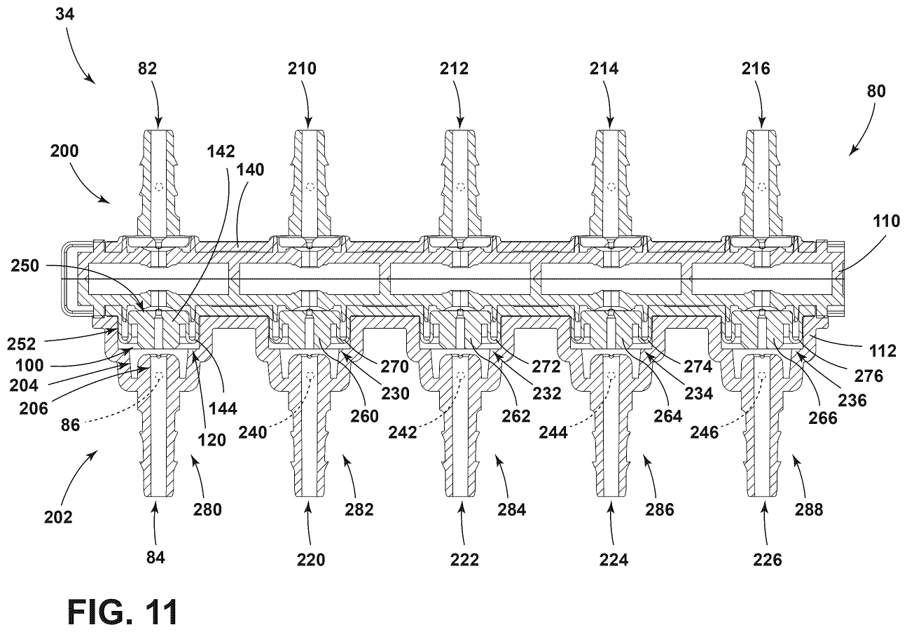

Referring to FIGS. 10 and 11, the valve housing 80 optionally includes a plurality of fluid inlets 200, a plurality of fluid outlets 202, a plurality of fluid chambers 204 (FIG. 11), and a plurality of exhaust outlets 206. For example, the plurality of fluid inlets 200 includes the fluid inlet 82 (e.g., a first fluid inlet), a second fluid inlet 210, a third fluid inlet 212, a fourth fluid inlet 214, and/or a fifth fluid inlet 216, the plurality of fluid outlets 202 includes the fluid outlet 84 (e.g., a first fluid outlet), a second fluid outlet 220, a third fluid outlet 222, a fourth fluid outlet 224, and/or a fifth fluid outlet 226. Optionally, the first housing member 110 and the second housing member 112 are laser welded together.

Referring to FIG. 11, the plurality of fluid chambers 204, for example, includes the fluid chamber 120 (e.g., a first fluid chamber), a second fluid chamber 230, a third fluid chamber 232, a fourth fluid chamber 234, and/or a fifth fluid chamber 236, which are separate from each other (e.g., not fluidly coupled). The first housing member 110 includes the plurality of fluid inlets 200. The second housing member 112 includes the plurality of fluid outlets 202. The first housing member 110 and the second housing member 112 cooperate to at least partially define the plurality of fluid chambers 204.

The second housing member 112 includes the plurality of exhaust outlets 206, which are fluidly coupled with respective fluid chambers 204. For example, the plurality of exhaust outlets 206 include the exhaust outlet 86 (e.g., a first exhaust outlet), a second exhaust outlet 240 fluidly coupled with the second fluid chamber 230, a third exhaust outlet 242 fluidly coupled with the third fluid chamber 232, a fourth exhaust outlet 244 fluidly coupled with the fourth fluid chamber 234, and/or a fifth exhaust outlet 246 fluidly coupled with the fifth fluid chamber 236.

The diaphragm 100 is disposed at least partially in the plurality of fluid chambers 204. The diaphragm 100 includes a plurality of bodies 250 and a plurality of flexible arms 252 flexibly connecting the bodies 250 to the flange 140 such that the bodies 250 can move (e.g., via flexing of the flexible arms 252) between default (e.g., retracted) positions and extended positions. For example, the plurality of bodies 250 includes the body 142 (e.g., a first body) disposed in the fluid chamber 120, a second body 260 disposed in the second fluid chamber 230, a third body 262 disposed in the third fluid chamber 232, a fourth body 264 disposed in the fourth fluid chamber 234, and/or a fifth body 266 disposed in the fifth fluid chamber 236. The plurality of flexible arms 252 includes the flexible arm 144 (e.g., a first flexible arm) flexibly connecting the body 142 with the flange 140, a second flexible arm 270 flexibly connecting the second body 260 with the flange 140, a third flexible arm 272 flexibly connecting the third body 262 with the flange 140, a fourth flexible arm 274 flexibly connecting the fourth body 264 with the flange 140, and/or a fifth flexible arm 276 flexibly connecting the fifth body 266 with the flange 140. The diaphragm 100 is optionally formed as a single, monolithic component. Each of the bodies 250 is configured to move (e.g., via flexing of the respective flexible arms 252) between default positions and extended positions in accordance with the pressure differential between the respective fluid inlets 200 and fluid outlets 202 and independently of the other bodies 250 and the pressure differentials in the other fluid chambers 204. For example, the fluid inlets 200, the fluid outlets 202, the fluid chambers 204, the exhaust outlets 206, and the bodies 250 and flexible arms 252 of the diaphragm 100 define respective independently operable valves 280, 282, 284, 286, 288 of the valve assembly 34. In the first positions, the bodies 250 are in contact with the first housing member 110 such that fluid flow from the fluid inlets 200 to the fluid outlets 202 is restricted and/or prevented. In the second positions, the bodies 250 are in contact with the fluid outlets 202 to facilitate flow from the fluid inlets 200 to the fluid outlets 202. One or more of the valves 280-288 can be configured as illustrated in FIGS. 3 and 4 (e.g., with respective bleed ports, such as the bleed port 90), and/or one or more of the valves 280-288 can be configured as illustrated in FIGS. 7-9 (e.g., with respective bleed channels, such as the bleed channel 180). The illustrated includes five valves 280-288 but can include other numbers of valves.

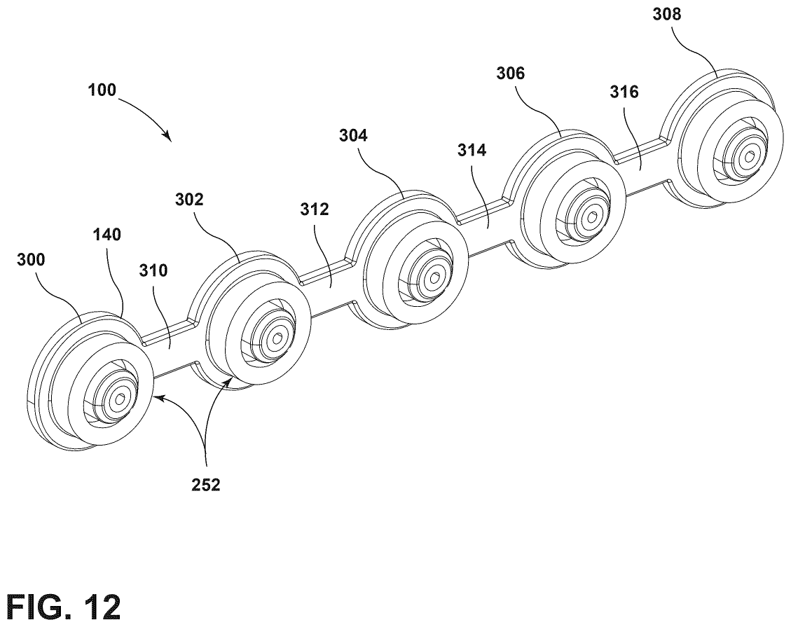

A perspective view of the diaphragm 100 including the flange 140, the bodies 250, and the flexible arms 252 is illustrated in FIG. 12. The flange 140 includes circular sections 300-308 connected with each of the flexible arms 252, and rectangular sections 310-316 connecting the circular sections 300-308.

The diaphragm 100 includes a plurality of positions according to the respective positions of the bodies 142. For example, a first position of the diaphragm 100 includes all of the bodies 142 in default positions. A second position of the diaphragm 100 includes the first body 142 in the extended position and the bodies 260-266 in the default positions. A third position of the diaphragm 100 includes the first and second bodies 142, 260 in the extended position and the bodies 262-266 in the default positions. The diaphragm 100 flexes from the first position to the second position according to a first pressure difference in the first fluid chamber 120, and flexes from the second position to the third position according to a second pressure difference in the second fluid chamber 260. The second pressure difference is independent of the first pressure difference.

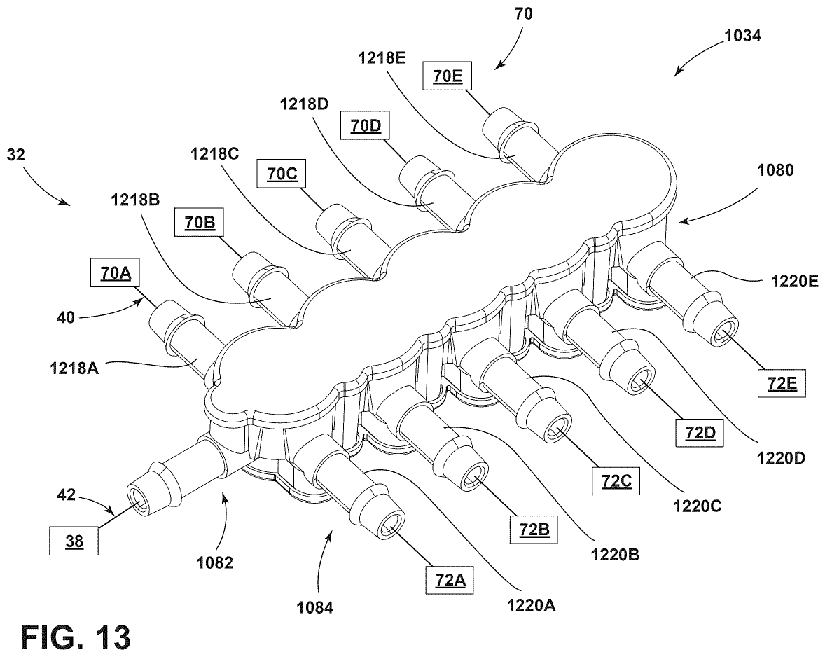

Referring to FIG. 13, a perspective view illustrates a valve assembly 1034 that can be utilized as the valve assembly 34 of FIG. 1. The valve assembly 1034 includes a valve housing 1080, a fluid inlet 1082, and a plurality of fluid outlets 1084. The fluid inlet 1082 is configured for fluidly coupling with the fluid source 38, such as via the fluid conduit 42. The fluid outlets 1084 are configured for fluid coupling with respective fluid bladders 70, such as via the fluid conduits 40. The bladders 70 include bladders 70A-E and bladders 72A-E, which can each include one or more bladders. In the illustrated example, the fluid outlets 1084 include a pair of first fluid outlets 1218A, 1220A fluidly coupled with the bladders 70A, 72A, a pair of second fluid outlets 1218B, 1220B fluidly coupled with the bladders 70B, 72B, a pair of third fluid outlets 1218C, 1220C fluidly coupled with the bladders 70C, 72C, a pair of fourth fluid outlets 1218D, 1220D fluidly coupled with the bladders 70D, 72D, and a pair of fifth fluid outlets 1218E, 1220E fluidly coupled with the bladders 70E, 72E.

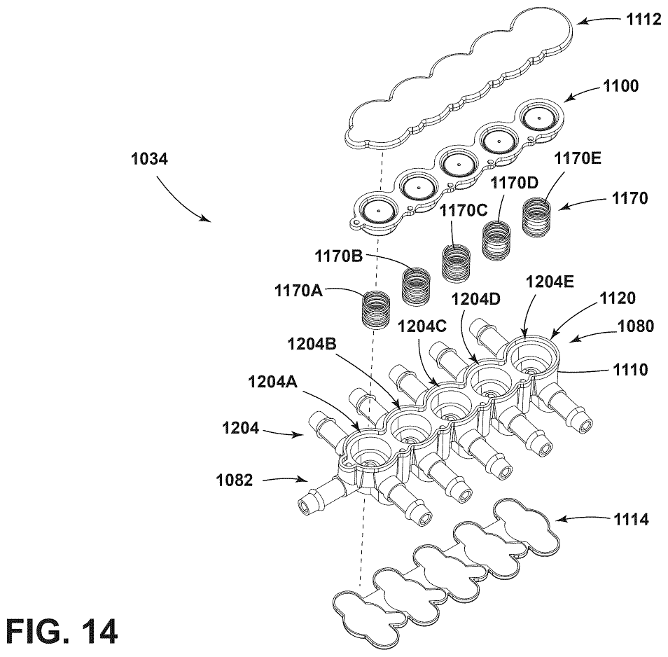

Referring to FIG. 14, an exploded perspective view illustrates the valve assembly 1034 with the valve housing 1080 including a first housing member 1110, a second housing member 1112, and a third housing member 1114. The first housing member 1110 includes the fluid inlet 1082 and the plurality of fluid outlets 1084. The first housing member 1110 at least partially defines a plurality of fluid chambers 1204 that are each fluidly coupled with a respective pair of the fluid outlets 1084. For example, the fluid chambers 1204 include a first fluid chamber 1204A, a second fluid chamber 1204B, a third fluid chamber 1204C, a fourth fluid chamber 1204D, and/or a fifth fluid chamber 1204E. The valve assembly 1034 includes a diaphragm 1100 disposed partially in each of the fluid chambers 1204. The valve assembly 1034 optionally includes a plurality of springs 1170, such as springs 1170A-E, biasing the diaphragm 1100 toward a first position.

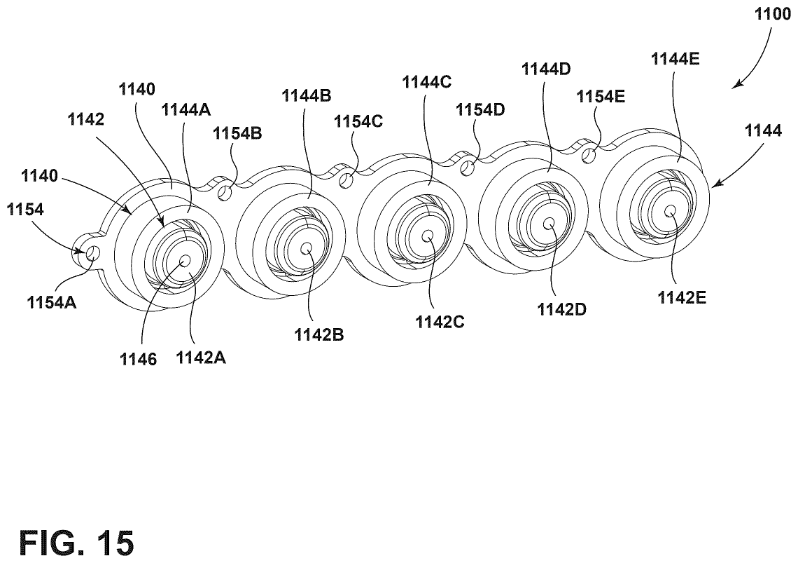

Referring to FIG. 15, a perspective view illustrates the diaphragm 1100. The diaphragm 1100 includes a flange 1140, a plurality of bodies 1142, and a plurality of flexible arms 1144 flexibly connecting the bodies 1142 to the flange 1140 such that the bodies 1142 are movable between default and extended positions. The bodies 1142 include a first body 1142A, a second body 1142B, a third body 1142C, a fourth body 1142D, and/or a fifth body 1142E, which are disposed in respective fluid chambers 1204 (FIG. 14). The flexible arms 1144 include a first flexible arm 1144A flexibly connecting the first body 1142A with the flange 1140, a second flexible arm 1144B flexibly connecting the second body 1142B with the flange 1140, a third flexible arm 1144C flexibly connecting the third body 1142C with the flange 1140, a fourth flexible arm 1144D flexibly connecting the fourth body 1142D with the flange 1140, and/or a fifth flexible arm 1144E flexibly connecting the fifth body 1142E with the flange 1140 The bodies 1142 each include a through aperture 1146 for fluid flow. The flange 1140 includes a plurality of flange apertures 1154, such as first, second, third, fourth, and fifth flange apertures 1154A-E. The flange 1140 is disposed (e.g., fixedly clamped) between the first housing member 1110 and the second housing member 1112 (FIG. 14).

The diaphragm 1100 includes a plurality of positions according to the respective positions of the bodies 1142. For example, a first position of the diaphragm 1100 includes all of the bodies 1142 in default positions. A second position of the diaphragm 1100 includes the first body 1142A in the extended position and the bodies 1142B-E in the default positions. A third position of the diaphragm 1100 includes the first and second bodies 1142A-B in the extended position and the bodies 1142C-E in the default positions.

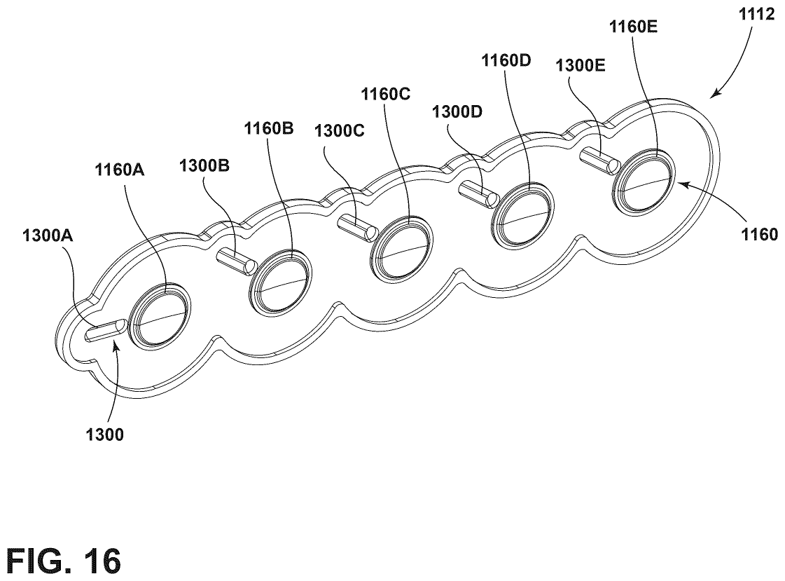

Referring to FIG. 16, a perspective view illustrates the second housing member 1112. The second housing member 1112 covers and partially defines the fluid chambers 1204 (FIG. 14). The second housing member 1112 includes a first contact surface 1160 for each of the bodies 1142 of the diaphragm 1100 (FIG. 15). For example, the first contact surfaces 1160 include first contact surfaces 1160A-E provided as circular protrusions extending into the fluid chambers 1120 (FIG. 14) to contact first body surfaces 1150A-E of the bodies 1142 (FIG. 14) when the bodies 1142 are in the default position. The second housing member 1112 includes a plurality fluid channels 1300, including a first fluid channel 1300A, a second fluid channel 1300B, a third fluid channel 1300C, a fourth fluid channel 1300D, and/or a fifth fluid channel 1300E.

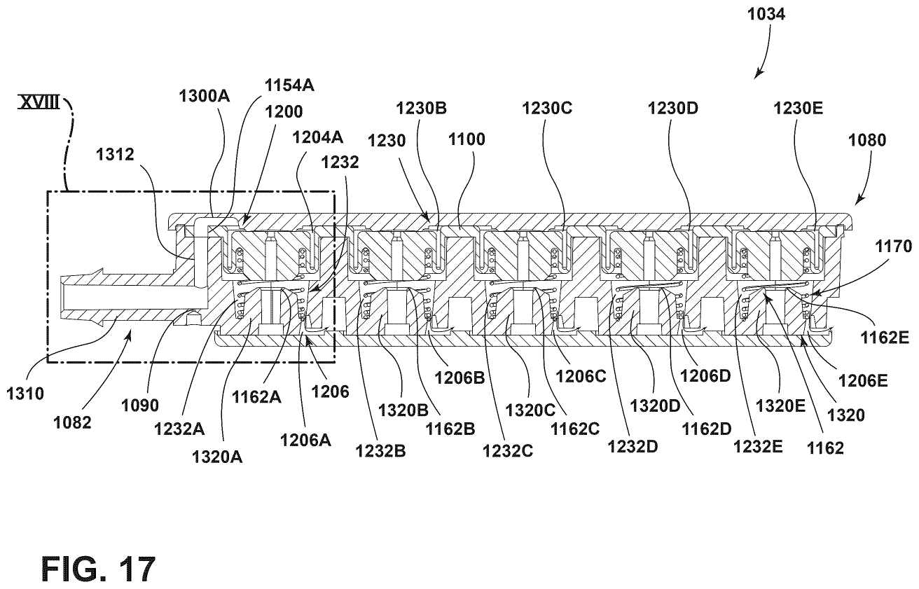

Referring to FIG. 17, a cross-sectional view illustrates the valve assembly 1034. The fluid inlet 1082 includes a first inlet section 1310 that extends from the valve housing 1080 for coupling with the fluid source 38 (FIG. 1), such as via one or more fluid conduits 42. The fluid inlet 1082 includes a second inlet section 1312 that extends in the valve housing 1080 (e.g., the first housing member 1110) from the first inlet section 1310 to the first flange aperture 1154A of the diaphragm 1100. The first flange aperture 1154A is at least partially aligned with the first fluid channel 1300A of the second housing member 1112, which is fluid coupled with the first fluid chamber 1204A such that the first inlet section 1310 is fluidly coupled with the first fluid chamber 1204A via the second inlet section 1312, the first flange aperture 1154A, and the first fluid channel 1300A. The valve housing 1080 includes a bleed port 1090 fluid coupled (e.g., directly) with the first inlet section 1310. In the illustrated example, the first inlet section 1310 and the second inlet section 1312 are perpendicular to each other, but can be disposed in other configurations.

The valve housing 1080 (e.g., the first housing member 1110) includes a plurality of outlet manifolds 1320, including first, second, third, fourth, and fifth outlet manifolds 1320A-E. The outlet manifolds 1320 extend into the fluid chambers 1204 and provide second contact surfaces 1162, such as second contact surfaces 1162A-E. The springs 1170 are disposed partially around respective bodies 1142 and outlet manifolds 1320.

The diaphragm 1100 separates each of the fluid chambers 1204 into first sections 1230, such as first sections 1230A-E and second sections 1232, such as second sections 1232A-E. The first sections 1230 are disposed between the diaphragm 1100 and the second housing member 1112. The second sections 1232 are disposed between the diaphragm 1100 and the first housing member 1110. The sizes (e.g., volumes) of the first and second sections 1230, 1232 vary depending on the positions of the bodies 1142. For example, the first sections 1230 are smaller with the bodies 1142 in the default positions than with the bodies 1142 in the extended positions, and the second sections 1232 are larger with the bodies 1142 in the default positions than with the bodies 1142 in the extended positions.

The valve housing 1080 includes a plurality of exhaust outlets 1206, such as exhaust outlets 1206A-E. The exhaust outlets 1206 are fluidly coupled with respective fluid chambers 1204 (e.g., the second sections 1232) and with the exterior of the valve housing 1080 (e.g., ambient air) to exhaust fluid from the valve housing 1080, such as fluid from the bladders 70 for deflation. In the default positions of the bodies 1142, the fluid outlets 1084 are fluidly coupled with the exhaust outlets 1206 via the second sections 1232, which allows deflating of the bladders 70 by allowing fluid to flow from the bladders 70, into the valve housing 1080 through the fluid outlets 1084, through the fluid chambers 1204, and through the exhaust outlets 1206 out of the valve housing 1080. In the extended positions of the bodies 1142, the bodies 1142 restrict or prevent fluid flow from the fluid outlets 1084 into the second sections 1232, which restricts or prevents fluid flow from the fluid outlets 1084 to the exhaust outlets 1206.

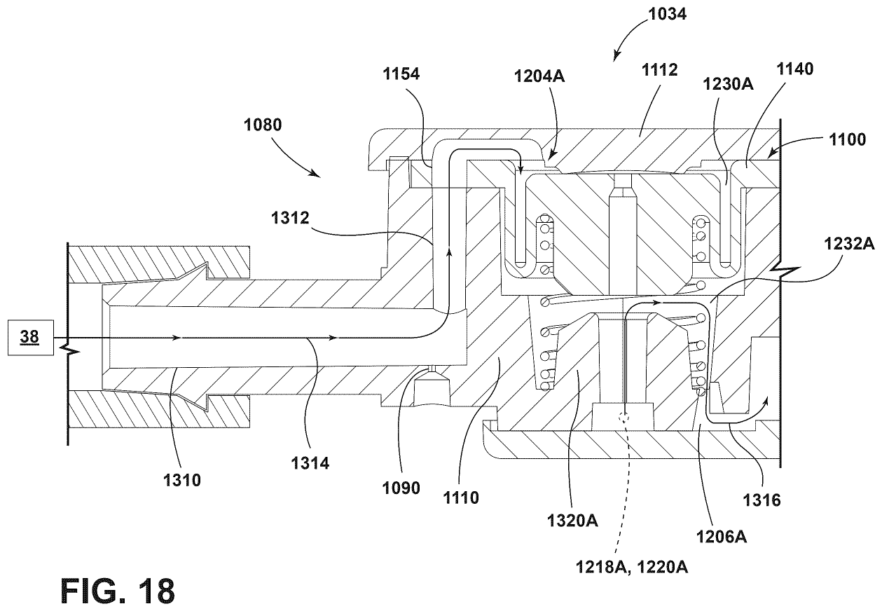

Referring to FIG. 18, an enlarged portion of FIG. 17 is provided and illustrates the flow of fluid (arrow 1314) from the fluid source 38, through one or more fluid conduits 40, through the first inlet section 1310, through the second inlet section 1312, through the flange aperture 1154A, through the first fluid channel 1300A, and into the first section 1230A of the first fluid chamber 1204A. Fluid continues to flow into the first section 1230A, and when the fluid pressure exceeds the threshold, the first body 1142A will move toward the extended position. FIG. 18 also illustrates the flow of fluid (arrow 1316) from the first and second fluid outlets 1218A, 1220A (e.g., from the bladders 70A, 72A shown in FIG. 13), through the first outlet manifold 1320A, into the second section 1232A of the first fluid chamber 1204A, through the exhaust outlet 1206A out of the valve housing 1080.

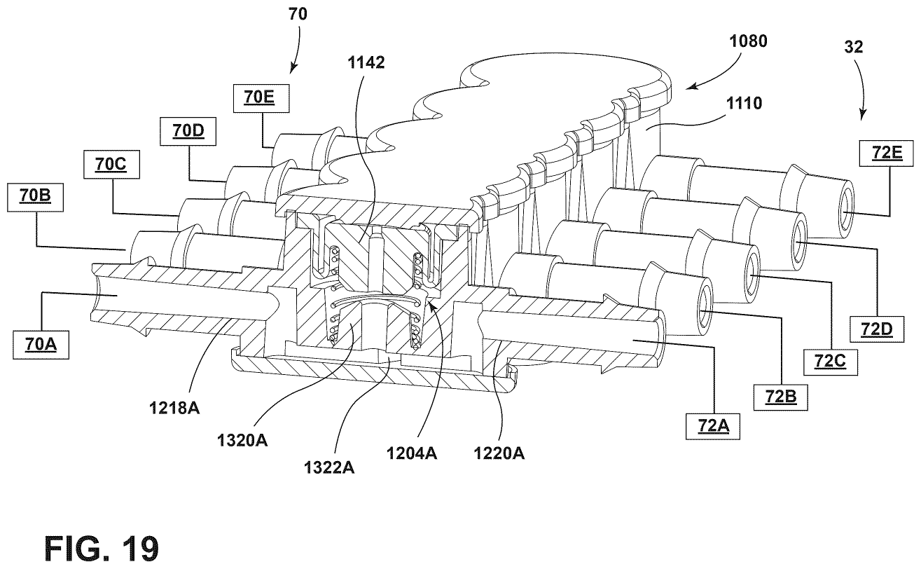

Referring to FIG. 19, a cross-sectional view taken through the first fluid chamber 1204A the pair of first fluid outlets 1218A, 1220A and the first outlet manifold 1320A is illustrated. The valve housing 1080 (e.g., the first housing member 1110) includes a first connecting passage 1322A. The first outlet manifold 1320A is fluidly coupled with the pair of first fluid outlets 1218A, 1220A and the first connecting passage 1322A. With the first body 1142A in the default position, the fluid source 38 (FIG. 1) is activated to provide fluid that flows into the first section 1230A of the first fluid chamber 1204A, the fluid pressure builds in the first section 1230A, and, when that fluid pressure exceeds a threshold, the first body 1142A moves from the default position to the extended position.

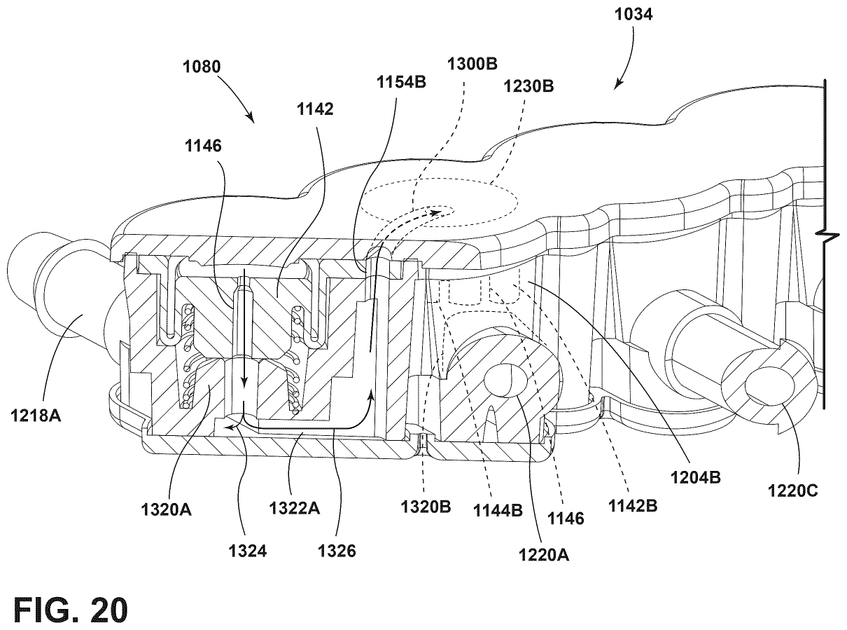

Referring to FIG. 20, in the extended position, the first body 1142A fluidly couples the first outlet manifold 1320A with the fluid source 38 (FIG. 19) such that fluid flows through the through aperture 1146 of the first body 1142A into the first outlet manifold 1320A, and through the first outlet manifold 1320A to (i) the pair of first fluid outlets 1218A, 1220A (FIG. 19) to inflate respective bladders 70A, 70B of the bladder assembly 32 (FIG. 19), as illustrated by arrow 1324, and (ii) into the first connecting passage 1322A, as illustrated by arrow 136. The first connecting passage 1322A extends at least partially through the valve housing 1080 (e.g., the first housing member 1110) from the first outlet manifold 1320A to the second flange apertures 1154B, which at least partially aligned with and fluidly coupled with the second fluid channel 1300B, which is fluidly coupled with the second fluid chamber 1204B. For example, with the first body 1142A in the extended position, the fluid source 38 is fluidly coupled with the second fluid chamber 1204B. While the bladders 70A, 70B (FIG. 19) are filling with fluid, the first fluid outlets 1218A 1220A provide less resistance to flow than the second fluid chamber 1204B (e.g., as a result of the spring 1170B and/or prestress of the second flexible arm 1144B—FIG. 17), and most of the fluid from the first outlet manifold 1320A, flows into the first fluid outlets 1218A 1220A.

Once the bladders 70A, 70B (FIG. 19) are full (e.g., reach a threshold fluid/pressure level), most or all of the fluid from the first outlet manifold 1320A flows into the first connecting passage 1322A and then into the first section 1230B of the second fluid chamber 1204B such that the second fluid chamber 1204B is indirectly fluidly coupled with and receives fluid from the fluid source 38. With the second body 1142B in the first position, fluid pressure builds in the first section 1230B until pressure threshold is met, and then the second body 1142B moves toward the extended position, which allows fluid to flow through the through aperture 1146 of the second body 1142B and into the second outlet manifold 1320B to fill the bladders 72A, 72B (FIG. 19) fluidly coupled with the pair of second fluid outlets 1218A, 1220A. A corresponding process is repeated for each subsequent fluid chamber 1204C-E, diaphragm body 1142C-E, and pair of fluid outlets 1218C-E and 1220C-E to successively fill sets of the bladders 70C-E and 72C-E. For example, inflating the bladders 70 includes filling the bladders 70A, 72A (e.g., to the threshold level) first, then the bladders 70B, 72B, then the bladders 70C, 72C, then the bladders 70D, 72D, and then the bladders 70E, 72E, which provides a wave effect during inflation.

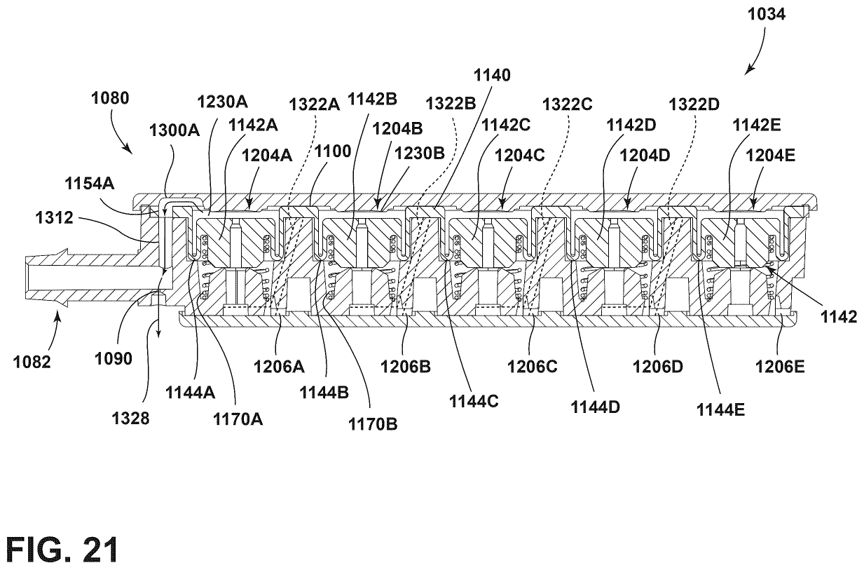

With all of the bladders 70 filled to threshold levels and the fluid source 38 providing fluid, all of the bodies 1142 are disposed in extended positions, such as generally illustrated in FIG. 21. In such a configuration, all of the bladders 70 are fluidly coupled with the fluid source 38 (FIG. 13).

To deflate the bladders 70 (FIG. 19), the fluid source 38 (FIG. 19) stops providing fluid to the fluid inlet 1082, and the fluid in the first fluid chamber 1204A (e.g., in the first section 1230A) flows back through the first fluid channel 1300A, through the flange aperture 1154A, through the second inlet section 1312, into the first inlet section 1310, and out of the valve housing 1080 through the bleed port 1090, such as illustrated by arrow 1328. Such flow through the bleed port 1090 reduces the fluid pressure in the first section 1230A below the threshold, which allows the spring 1170A and/or the prestress of the first flexible arm 1144A to move the first body 1142A from the extended position toward the default position. The first body 1142A moving out of the extended position fluidly couples the first outlet manifold 1320A with the exhaust outlet 1206A to allow deflation of the bladders 70A, 72A (FIG. 19) through the exhaust outlet 1206A in addition to the bleed port 1090. The first body 1142A moving out of the extended position also fluidly couples the first section 1230B of the second fluid chamber 1204B with the exhaust outlet 1206A, which reduces the fluid pressure in the first section 1230B below the threshold and allows the spring 1170B and/or the prestress of the second flexible arm 1144B to move the second body 1142B from the extended position toward the default position to open the exhaust outlet 1206B and deflate the bladders 70B, 72B (FIG. 19). This process continues with each body 1142C-E moving out of the extended position to open the respective exhaust outlets 1206C-E to deflate the pairs of bladders 70C-E, 72C-E (FIG. 19) and allow the adjacent body 1142C-E to move out of the extended position. This process provides successive deflation of the bladders 70 (FIG. 19) in the same order of inflation, which provides a wave-like inflation-deflation pattern. For example, the bladders 70A, 70B (FIG. 19) are the first to inflate and first to deflate, and the bladders 70E, 72E (FIG. 19) are the last to inflate and last to deflate. The valve assembly 1034 is shown with five fluid chambers 1120 but can include other numbers of fluid chambers.

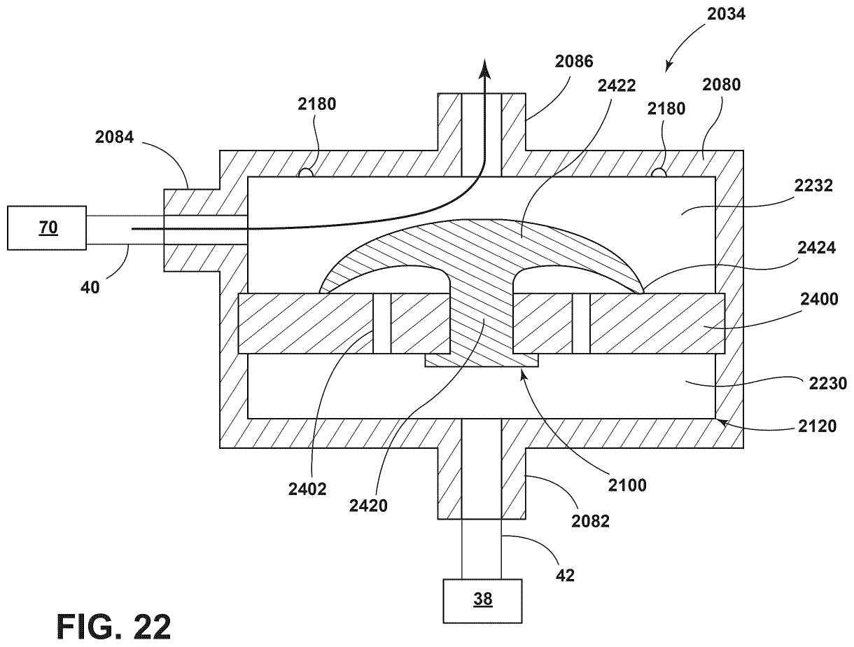

Referring to FIG. 22, a perspective view illustrates a valve assembly 2034 that can be utilized as the valve assembly 34 of FIG. 1. The valve assembly 2034 includes a valve housing 2080, a fluid inlet 2082, a fluid outlet 2084, and an exhaust outlet 2086. The fluid inlet 2082 is configured for fluidly coupling the valve housing 2080 with the fluid source 38, such as via the fluid conduit 42. The fluid outlet 2084 is configured for fluidly coupling the valve housing 2080 with one or more fluid bladders 70, such as via the fluid conduit 40. The exhaust outlet 2086 fluidly couples the valve housing 2080 with a region of relatively low fluid pressure, such as ambient air.

The valve housing 2080 at least partially defines a fluid chamber 2120 fluidly coupled with the fluid inlet 2082, the fluid outlet 2084, and the exhaust outlet 2086. The valve assembly 2034 includes a diaphragm 2100 disposed in the fluid chamber 2120, and a wall 2400 (e.g., an internal wall, a plate, etc.) separating the fluid chamber 2120 into a first section 2230 and a second section 2232. The first section 2230 is fluidly coupled with the fluid inlet 2082. The second section 2232 is fluidly coupled with the fluid outlet 2084 and the exhaust outlet 2086. The wall 2400 includes a set of one or more fluid passages 2402 that extend through the wall 2400. The diaphragm 2100 is coupled to (e.g., fixed to) the wall 2400.

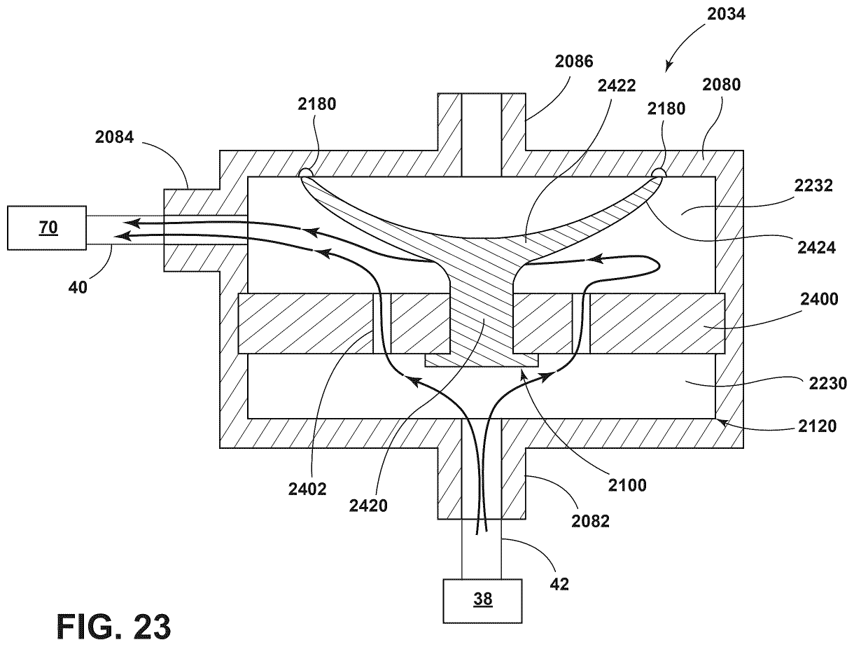

The diaphragm 2100 includes a base 2420 and a flexible dome 2422 extending from the base 2420. The base 2420 is coupled to the wall 2400 and the flexible dome 2422 is disposed in the second section 2232. The flexible dome 2422 can be flexed between a first position shown in FIG. 22 and a second position shown in FIG. 23. In the first position (e.g., a default position) shown in FIG. 22, the flexible dome 2422 covers the set of fluid passages 2402, restricting or preventing fluid flow from the fluid inlet 2082 to the fluid outlet 2084 or the exhaust outlet 2086, and from the fluid outlet 2084 or the exhaust outlet 2086 to the fluid inlet 2082. In the first position, the diaphragm 2100 does not restrict fluid between the fluid outlet 2084 and the fluid inlet 2082, which allows deflation of the bladder 70 via fluid flow from the bladder 70, through the fluid outlet 2084 into the second section 2232, through the second section 2232 to the exhaust outlet 2086, and through the exhaust outlet 2086 out of the valve assembly 2034. In the first position, the flexible dome 2422, for example, includes a first U-shaped cross-sectional shape that opens toward the wall 2400, and an outer edge 2424 (e.g., an annular edge) of the flexible dome 2422 is in contact with the wall 2400 radially outward of the set of fluid passages 2402. The flexible dome 2422 is prestressed toward the first position.

In the second position (e.g., an extended position) shown in FIG. 23, the flexible dome 2422 is flexed away from the wall 2400 such that the flexible dome 2422 does not materially restrict fluid flow from the fluid inlet 2082 to the fluid outlet 2084, allowing for inflation of the bladder 70. In the second position, the outer edge 2424 is in contact with the valve housing 1080 such that the exhaust outlet 2086 is covered and fluid flow from the fluid inlet 2082 and the fluid outlet 2084 into the exhaust outlet 2086 is restricted or prevented, restricting or preventing deflation of the bladder 70 via the exhaust outlet 2086.

The flexible dome 2422 flexes between the first position and the second position according to a fluid pressure in the first section 2230. For example, when the fluid pressure in the first section 2230 is at or below a pressure threshold, the flexible dome 2422 remains in or flexes to or toward the first position. When the fluid pressure in the first section 2230 exceeds the pressure threshold, the flexible dome 2422 flexes to or toward the second position. The pressure threshold corresponds to a fluid pressure (e.g., a pressure differential across the flexible dome 2422) sufficient to overcome a spring or prestress force of the flexible dome 2422. The fluid source 38 is configured to provide fluid to the first section 2230 that exceeds the pressure threshold, which causes the flexible dome 2422 to move to or toward the second position and inflates the bladder 70.

At least one of the valve housing 2080 or the diaphragm 2100 provides a bleed channel 2180 at the contact region between the valve housing 2080 and the diaphragm 2100 with the diaphragm 2100 in the second position. The bleed channel 2180 is, for example, provided as a recess in the valve housing 2080, provided via a protrusion of the diaphragm 2100 (e.g., which spaces adjacent portions of the diaphragm 2100 from the surface of the valve housing 2080), provided via increased surface roughness of the valve housing 2080, provided via increased surface roughness of the diaphragm 2100, or combinations thereof. The bleed channel 2180 allows at least some amount of fluid to flow from the bladder 70 to the exhaust outlet 2086 with the flexible dome 2422 in the second position to facilitate deflation (e.g., automatic deflation) of the bladder 70. For example, with the fluid source 38 not providing fluid and with the flexible dome 2422 in the second position, fluid flows from the bladder 70 through the bleed channel 2180 to the exhaust outlet 2086, which continues to lower the fluid pressure in the first section 2230 until the spring or prestress force of the flexible dome 2422 causes the flexible dome 2422 to flex back to the first position.

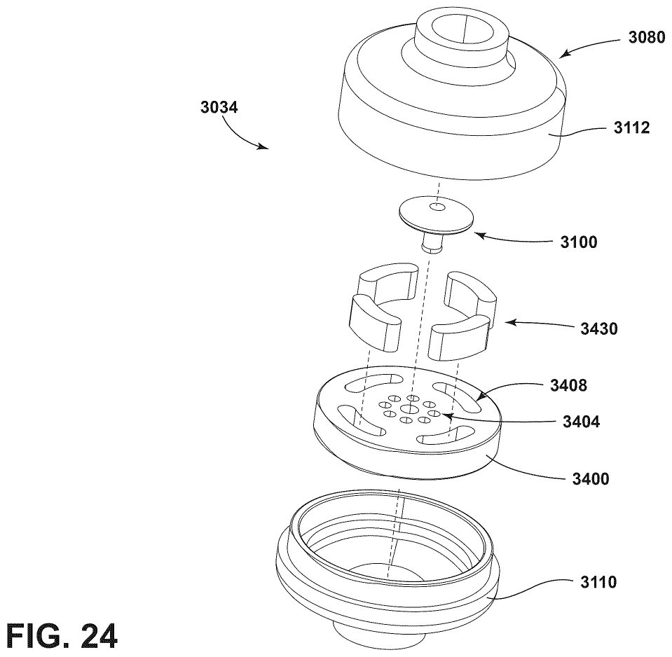

Referring to FIG. 24, a perspective view illustrates a valve assembly 3034 that can be utilized as the valve assembly 34 of FIG. 1. The valve assembly 3034 includes a valve housing 3080, a fluid inlet 3082, and a fluid outlet 3084. The fluid inlet 3082 is configured for fluidly coupling the valve housing 3080 with the fluid source 38, such as via the fluid conduit 42. The fluid outlet 3084 is configured for fluid coupling the valve housing 3080 with one or more respective fluid bladders 70, such as via the fluid conduit 40. The valve housing 3080 includes a first housing member 3110, a second housing member 3112, a diaphragm 3100, and a wall 3400 (e.g., an internal wall, a plate, etc.). Optionally, the valve assembly 3034 includes a set of one or more inserts 3430.

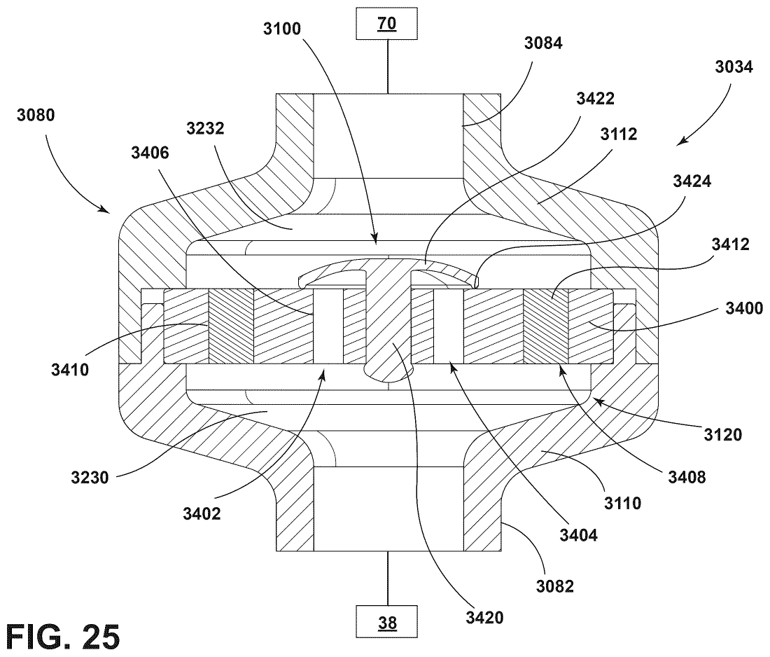

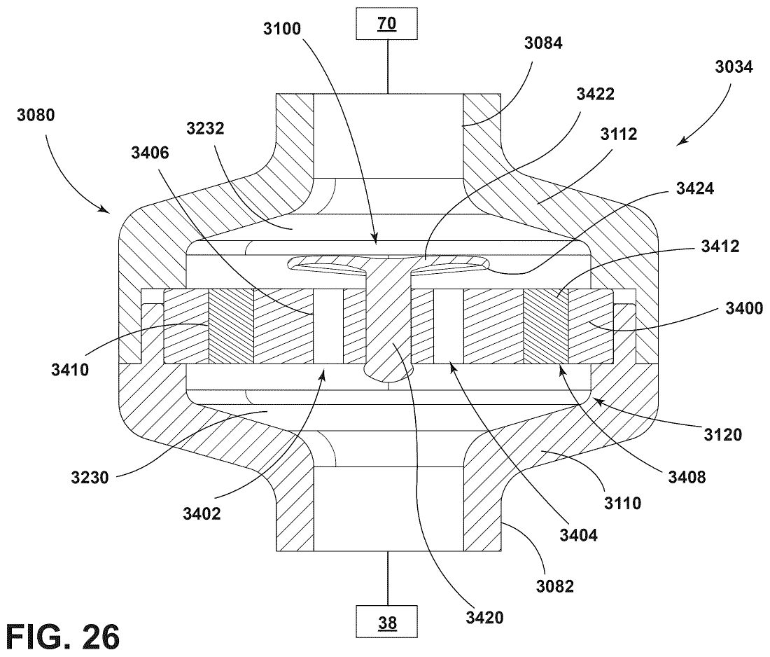

Referring to FIGS. 25 and 26, the first housing member 3110 and the second housing member 3112 at least partially define a fluid chamber 3120 fluidly coupled with the fluid inlet 3082 and the fluid outlet 3084. The diaphragm 3100 is disposed in the fluid chamber 3120, and the wall 3400 separates the fluid chamber 3120 into a first section 3230 and a second section 3232. The first section 3230 is fluidly coupled with the fluid inlet 3082. The second section 3232 is fluidly coupled with the fluid outlet 3084. The wall 3400 includes a set of one or more fluid passages 3402 that extend through the wall 3400. The diaphragm 3100 is coupled to (e.g., fixed to) the wall 3400.

The diaphragm 3100 includes a base 3420 and a flexible dome 3422 extending from the base 3420. The base 3420 is coupled to the wall 3400 and the flexible dome 3422 is disposed in the second section 3232. The flexible dome 3422 can be flexed between a first position shown in FIG. 25 and a second position shown in FIG. 26. In the first position (e.g., a default position) shown in FIG. 25, the flexible dome 3422 covers a first subset 3404 of the set of fluid passages 3402, such as a first fluid passage 3406, restricting or preventing fluid flow from the fluid inlet 3082 through the first fluid passage 3406 to the fluid outlet 3084, and from the fluid outlet 3084 through the first fluid passage 3406 to the fluid inlet 3082. In the first position, the flexible dome 3422, for example, includes a first U-shaped cross-sectional shape that opens toward the wall 3400, and an outer edge 3424 (e.g., an annular edge) of the flexible dome 3422 is in contact with the wall 3400 radially outward of the first subset of fluid passages 3404 of the set of fluid passage 3402. The flexible dome 3422 is prestressed toward the first position.

In the second position (e.g., an extended position) shown in FIG. 26, the flexible dome 3422 is flexed away from the wall 3400 such that the flexible dome 3422 does not materially restrict fluid flow from the fluid inlet 3082 through the first subset of fluid passages 3404 to the fluid outlet 3084, allowing for inflation of the bladder 70. In the second position, the flexible dome 3422, for example, includes a second U-shaped cross-sectional shape that opens away from the wall 3400, and the outer edge 3424 is spaced from the wall 3400.

The flexible dome 3422 flexes between the first position and the second position according to a fluid pressure in the first section 3230 (e.g., compared to a fluid pressure in the second section 3232). For example, when the fluid pressure in the first section 3230 is at or below a pressure threshold, the flexible dome 3422 remains in or flexes to or toward the first position. When the fluid pressure in the first section 3230 exceeds the pressure threshold, the flexible dome 3422 flexes to or toward the second position. The pressure threshold corresponds to a fluid pressure (e.g., a pressure differential across the flexible dome 3422) sufficient to overcome a spring or prestress force of the flexible dome 3422. The fluid source 38 is configured to provide fluid to the first section 3230 that exceeds the pressure threshold, which causes the flexible dome 3422 to move to or toward the second position and inflates the bladder 70.

A second subset of fluid passages 3408 of the set of fluid passages 3402 includes a second fluid passage 3410. The second subset of fluid passages 3408 are configured to allow fluid flow at a non-zero rate through the wall 3400 regardless of the position of the diaphragm 3100. Optionally, a porous medium 3412, such as in the form of the set of inserts 3430 (FIG. 24), is disposed in the second subset of fluid passages 3408 to control the flow rate. When the fluid source 38 provides fluid to the fluid inlet 3082, the fluid flows into the first subset of fluid passages 3404 and the second subset of fluid passages 3408. The fluid flows through the second subset of fluid passages 3408 to the fluid outlet 3084 (e.g., immediately). Once the pressure threshold is reached, the fluid flows from the first subset of fluid passages 3404 and the second subset of fluid passages 3408 to the fluid outlet 3084. When the fluid source 38 is not providing fluid to the fluid inlet 3082, fluid from the bladder 70 flows into the fluid outlet 3084 and through the second subset of fluid passages 3408, while the diaphragm 3100 restricts or prevents fluid flow through the first subset of fluid passages 3404, such that the deflation rate is slower than the inflate rate. Optionally, with a reversed configuration, the fluid source 38 is fluidly coupled with the fluid outlet 3084, and the bladder 70 is fluidly coupled with the fluid inlet 3082, such as to provide slower inflation and faster deflation.

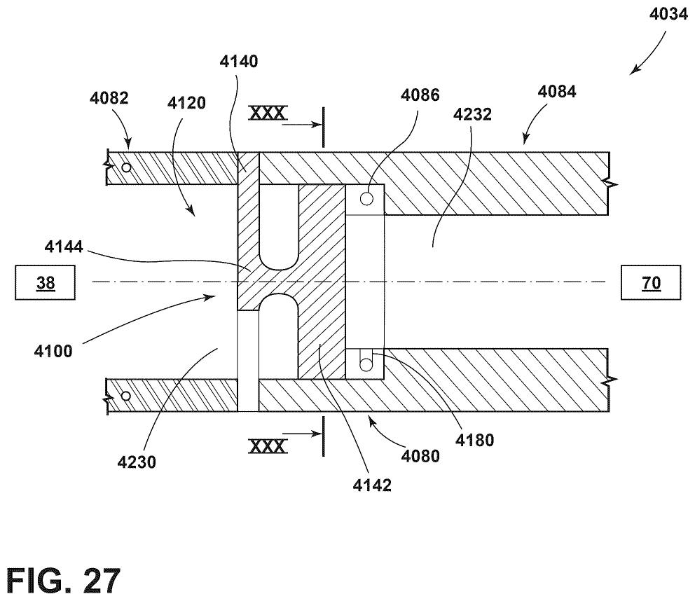

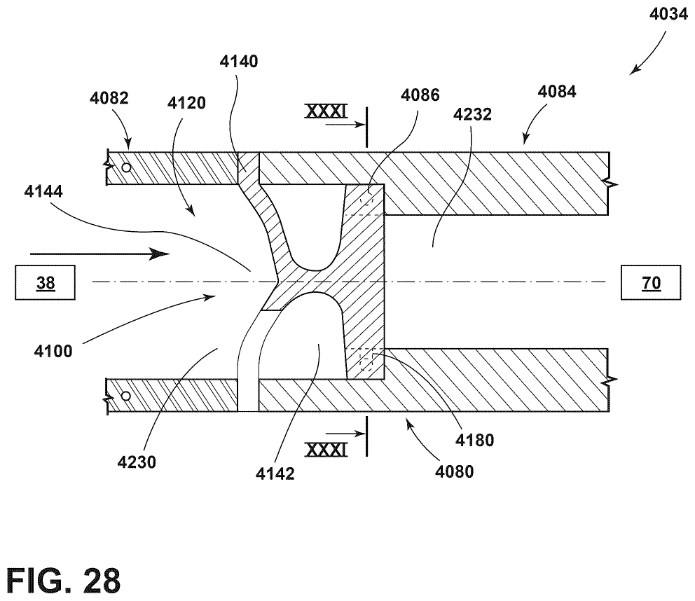

Referring to FIGS. 27 and 28, cross-sectional views illustrate a valve assembly 4034 that can be utilized as the valve assembly 34 of FIG. 1. The valve assembly 4034 includes a valve housing 4080, a fluid inlet 4082, a fluid outlet 4084, and an exhaust outlet 4086. The fluid inlet 4082 is configured for fluidly coupling the valve housing 4080 with the fluid source 38 and/or the fluid conduit 42 (FIG. 1). The fluid outlet 4084 is configured for fluidly coupling the valve housing 4080 with one or more respective fluid bladders 70 and/or the fluid conduit 40 (FIG. 1). The exhaust outlet 4086 fluidly couples the valve housing 4080 with a region of low-pressure fluid, such as ambient air. The valve housing 4080 is optionally provided with a tube configuration.

The valve housing 4080 at least partially defines a fluid chamber 4120 fluidly coupled with the fluid inlet 4082 and the fluid outlet 4084. The valve assembly 4034 includes a diaphragm 4100 disposed in the fluid chamber 4120 and separating the fluid chamber 4120 into a first section 4230 and a second section 4232. The first section 4230 is fluidly coupled with the fluid inlet 4082. The second section 4232 is fluidly coupled with the fluid outlet 4084. The diaphragm 4100 is coupled to (e.g., fixed to) the valve housing 4080.

The diaphragm 4100 includes a flange 4140, a body 4142, and a flexible arm 4144 flexibly connecting the body 4142 with the flange 4140. The flange 4140 is coupled (e.g., fixed) to the valve housing 4080. The flexible arm 4144 is configured to flex to allow movement of the body 4142 in the fluid chamber 4120.

The diaphragm 4100 can be flexed between a first position shown in FIG. 27 and a second position shown in FIG. 28. In the first position (e.g., a default position) shown in FIG. 27, the body 4142 is offset from the exhaust outlet 4086 and does not restrict fluid flow from the fluid outlet 4084 to the exhaust outlet 4086, such as to facilitate deflating of the bladder 70 (FIG. 1). The flexible arm 4144 is prestressed toward the first position.

In the second position (e.g., an extended position) shown in FIG. 28, the flexible arm 4144 is flexed toward the fluid outlet 4084, which disposes the body 4142 such that the body 4142 covers the exhaust outlet 4086, restricting or preventing fluid flow into the exhaust outlet 4086, such as from the fluid inlet 4082 or the fluid outlet 4084.

The diaphragm 4100 flexes between the first position and the second position according to a fluid pressure differential across the diaphragm 4100, such as across the flexible arm 4144. For example, when the fluid pressure in the first section 4230 is at or below a pressure threshold, the diaphragm 4100 remains in or flexes to or toward the first position. When the fluid pressure in the first section 4230 exceeds the pressure threshold, the diaphragm 4100 flexes to or toward the second position. The pressure threshold corresponds to a fluid pressure (e.g., a pressure differential across the flexible arm 4144) sufficient to overcome a spring or prestress force of the flexible arm 4144. The fluid source 38 (FIG. 1) is configured to provide fluid to the first section 4230 that exceeds the pressure threshold, which causes the diaphragm 4100 to move to or toward the second position and inflates the bladder 70 (FIG. 1).

At least one of the valve housing 4080 or the diaphragm 4100 provides a bleed channel 4180 at the contact region between the valve housing 4080 and the diaphragm 2100 at or adjacent the exhaust outlet 4086 with the diaphragm 4100 in the second position. The bleed channel 4180 is, for example, provided as a recess in the valve housing 4080, provided via a protrusion of the diaphragm 4100 (e.g., which spaces adjacent portions of the diaphragm 4100 from the surface of the valve housing 4080), provided via increased surface roughness of the valve housing 4080, provided via increased surface roughness of the diaphragm 4100, or combinations thereof. The bleed channel 4180 allows at least some amount of fluid to flow from the bladder 70, through the fluid outlet 4084 to the exhaust outlet 4086 with the diaphragm 4100 in the second position to facilitate deflation (e.g., automatic deflation) of the bladder 70. For example, with the fluid source 38 not providing fluid and with the diaphragm 4100 in the second position, fluid flows from the bladder 70 into the fluid outlet 4084 through the bleed channel 4180 to the exhaust outlet 4086, which continues to lower the fluid pressure in the first section 4230 until the spring or prestress force of the diaphragm 4140 causes the diaphragm 4140 to flex back to the first position (e.g., for automatic passive deflation).

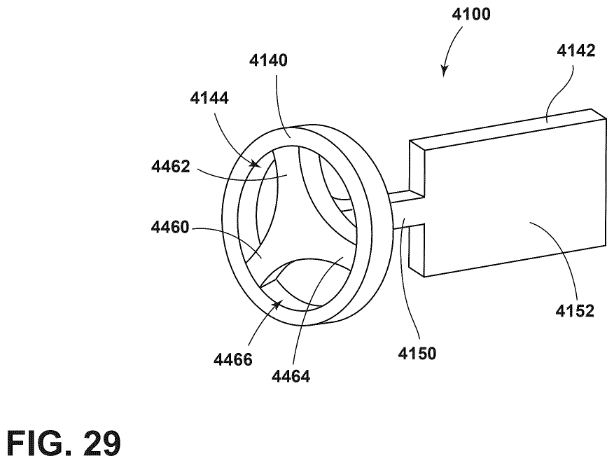

Referring to FIG. 29, a perspective view illustrates the diaphragm 4100 with the flange 4140, the body 4142, and the flexible arm 4144. In the illustrated example, the body 4142 includes a first body section 4150 and a second body section 4152. The first body section 4150 extends from the flexible arm 4144 to the second body section 4152. The second body section 4152 includes a rectangular configuration that has a greater radial extent than the first body section 4150. The flexible arm 4144 includes a first arm section 4460, a second arm section 4462, and a third arm section 4464 that extend radially outward to the flange 4140, such as in a 3-pointed star configuration. Fluid passages 4466 are provided between the flexible arm 4144 and the flange 4140. Fluid can flow through the fluid passages 4466 in all positions of the diaphragm 4100.

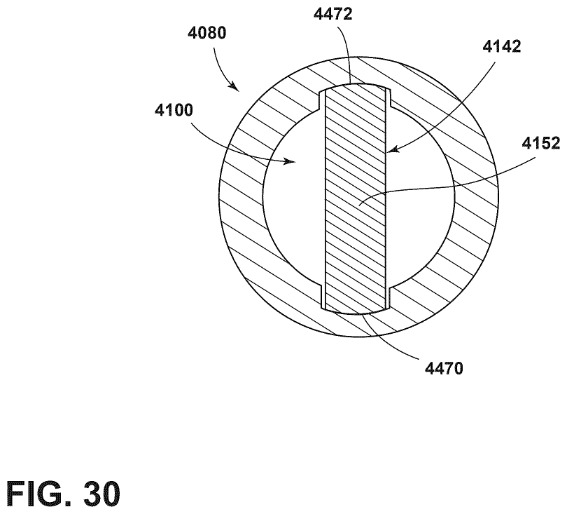

Referring to FIG. 30, a cross-sectional view of the valve assembly 4034 taken at line XXX-XXX in FIG. 27 is illustrated. The valve housing 4080 includes a first channel 4470 and/or a second channel 4472. The body 4142 (e.g., the second body section 4152) is partially disposed in the first channel 4470 and the second channel 4472, such as to guide movement of and/or restrict or prevent rotation of the body 4142.

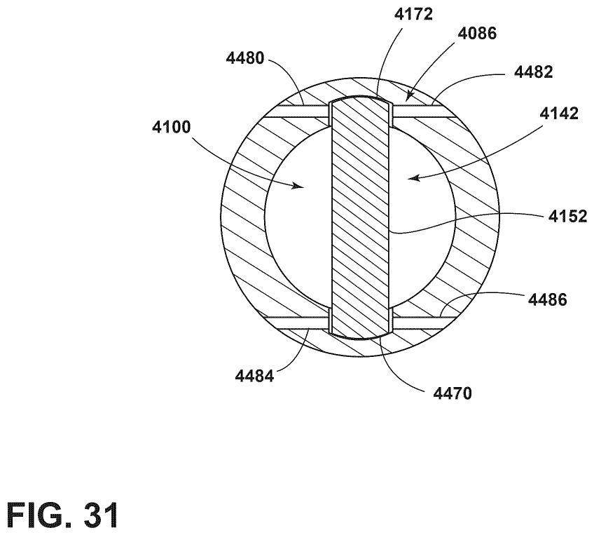

Referring to FIG. 31, a cross-sectional view of the valve assembly 4034 taken at line XXXI-XXXI in FIG. 28 is illustrated. The exhaust outlet 4086 includes four exhaust outlet portions 4480, 4482, 4484, 4486 that extend from the channels 4470, 4472 through the valve housing 4080. The diaphragm 4100 is shown in the second position and the body 4142 blocks the exhaust outlet portions 4480, 4482, 4484, 4486 such that fluid flow through the exhaust outlet portions 4480, 4482, 4484, 4486 is restricted or prevented.

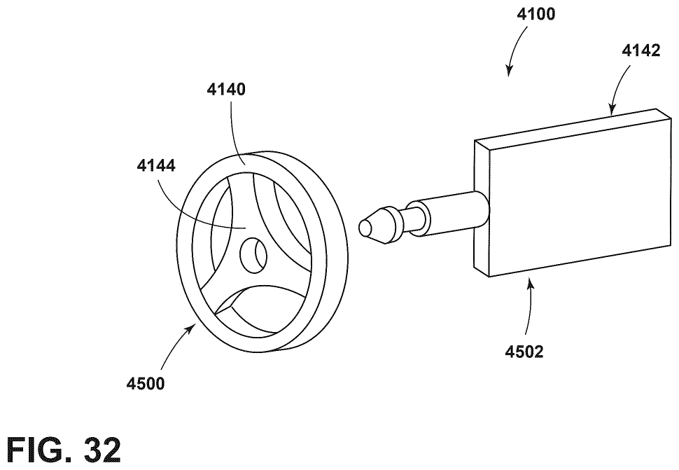

The diaphragm 4100 can be a single, monolithic component. Alternatively, as generally illustrated in FIG. 32, the diaphragm 4100 is optionally provided as a two-part assembly. With the two-part assembly, the flange 4140 and the flexible arm 4144 are integrally formed as a first part 4500, and the body 4142 formed as a second part 4502 configured for partial insertion into and engagement with the first part 4500.

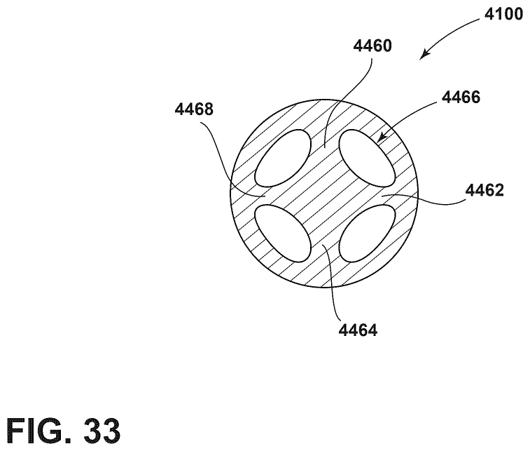

Referring to FIG. 33, the flexible arm 4144 of the diaphragm 4100 can include more than three arm sections, such as four arm sections, including the arm sections 4460-4464 and a fourth arm section 4468 that partially define four fluid passages 4466.

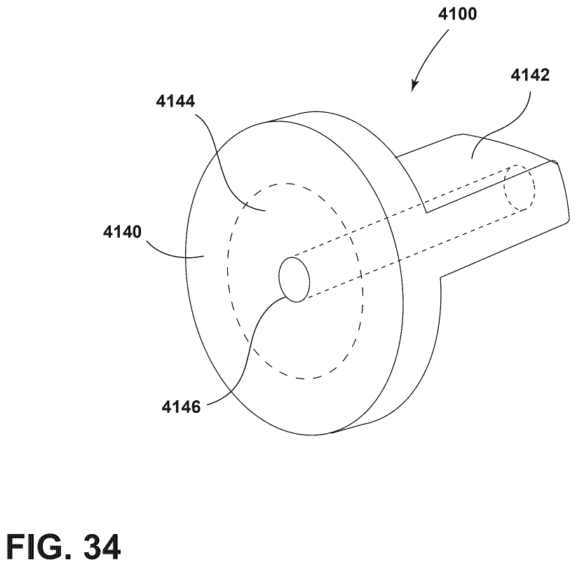

Referring to FIG. 34, the flexible arm 4144 of the diaphragm 4100 can include an annular configuration (e.g., instead of including multiple arm sections), and a through aperture 4146 can extend through the flexible arm 4144 and the body 4142.

With each of the valve assemblies 34, 1034, 2034, 3034, 4034, fluid can be provided to a fluid inlet to inflate one or more bladders, and fluid can be automatically and passively vented from the one or more bladders to deflate the bladders. For example, deflation of the bladders 70 can be carried out without an exhaust actuator.

With some examples, a valve assembly can include combinations of some or all of elements of the valve assemblies 34, 1034, 2034, 3034, 4034, which are not mutually exclusive. For example, a single valve assembly or a single seat assembly can include all of the valve assemblies 34, 1034, 2034, 3034, 4034 fluidly coupled with respective subsets of the bladders 70.

The instant disclosure includes the following non-limiting embodiments:

A fluid valve assembly for a seat comprising a fluid bladder, the fluid valve assembly comprising: a valve housing at least partially defining a first fluid inlet, a first fluid outlet, and a first exhaust outlet; a diaphragm disposed at least partially in the valve housing and configured to flex between a first position and a second position according to a first fluid pressure difference between the first fluid inlet and the first fluid outlet; wherein, in the first position, the diaphragm restricts fluid flow from the first fluid inlet to the first exhaust outlet and the first fluid outlet; and in the second position, the diaphragm permits flow from the first fluid inlet to the first fluid outlet and restricts fluid flow from the first fluid outlet to the first exhaust outlet.

The fluid valve assembly of any preceding embodiment, wherein, in the first position, the first exhaust outlet and the first fluid outlet are fluidly coupled; and in the second position of the diaphragm, the diaphragm restricts flow between the first fluid outlet and the first exhaust outlet.

The fluid valve assembly of any preceding embodiment, wherein the diaphragm comprises: a flange fixedly coupled with the valve housing; a body including a through aperture; and a flexible arm extending between and connecting the flange and the body.

The fluid valve assembly of any preceding embodiment, wherein the fluid valve assembly comprises a spring disposed at least partially around the body and biasing the diaphragm toward the first position.

The fluid valve assembly of any preceding embodiment, wherein the valve housing defines a first exhaust port and a first bleed port; and wherein the first bleed port is fluidly coupled with the first fluid outlet and the first exhaust outlet.

The fluid valve assembly of any preceding embodiment, wherein the valve housing defines a bleed channel provided via at least one of a recess, a protrusion, or increased surface roughness.

The fluid valve assembly of any preceding embodiment, wherein the bleed channel fluidly couples the first fluid outlet with the first exhaust outlet in the first position and the second position of the diaphragm.

The fluid valve assembly of any preceding embodiment, wherein the valve housing includes a contact surface; in the second position, the diaphragm is in contact with the contact surface; and the contact surface at least partially defines the bleed channel.

The fluid valve assembly of any preceding embodiment, wherein the fluid valve assembly is configured as a permanent deflate valve to facilitate deflation of the fluid bladder with the diaphragm in the first position.

The fluid valve assembly of any preceding embodiment, wherein the valve housing comprises a first housing member coupled with a second housing member; the first housing member and the second housing member cooperate to at least partially define a first fluid chamber; the diaphragm is disposed at least partially in the first fluid chamber; in the first position, the diaphragm is in contact with a first contact surface of the first housing member such that fluid flow through the diaphragm is restricted; and in the second position, the diaphragm is in contact with a second contact surface of the second housing member such that fluid flow to the first exhaust outlet is restricted.

The fluid valve assembly of any preceding embodiment, wherein the valve housing further defines a second fluid inlet, a second fluid outlet, and a second exhaust outlet; the first housing member and the second housing member cooperate to define a second fluid chamber separate from the first fluid chamber; the diaphragm includes a first arm and a first body disposed at least partially in the first fluid chamber, and a second arm and a second body disposed at least partially in the second fluid chamber; and the diaphragm is configured to flex between the second position and a third position according to a second fluid pressure difference between the second fluid inlet and the second fluid outlet, independent of the first fluid pressure difference.

The fluid valve assembly of any preceding embodiment, wherein the diaphragm is a monolithic component.

The fluid valve assembly of any preceding embodiment, wherein: the valve housing comprises a first housing member coupled with a second housing member; the first housing member and the second housing member cooperate to at least partially define a first fluid chamber and a second fluid chamber; the diaphragm includes a first body disposed at least partially in the first fluid chamber and a second body disposed at least partially in the second fluid chamber; the first fluid chamber includes a first section and a second section separated by the diaphragm; in the first position of the diaphragm, the second section of the first fluid chamber is fluidly coupled with the first fluid outlet; the valve housing defines a second fluid outlet; in the first position of the diaphragm, the second fluid chamber is fluidly coupled with the second fluid outlet; and in the second position of the diaphragm, the first fluid outlet is fluidly coupled with the first fluid inlet, and the second fluid chamber is fluidly coupled with the first fluid outlet.

The fluid valve assembly of any preceding embodiment, wherein, in the first position of the diaphragm, the first body and the second body are in disposed in default configurations; in the second position of the diaphragm, the first body is in an extended position and the second body is in disposed in the default configuration; and in a third position of the diaphragm, the second body is disposed in the extended configuration to fluidly couple the second fluid outlet with the first fluid inlet via a through aperture of the first body and the first fluid outlet.

The fluid valve assembly of any preceding embodiment, wherein, in the first position of the diaphragm, the first fluid outlet and a first section of the second fluid chamber are fluidly coupled with the first exhaust outlet.

A vehicle seat assembly, comprising: the fluid valve assembly of any preceding embodiment; and the fluid bladder fluidly coupled with the first fluid outlet.

The fluid valve assembly of any preceding embodiment wherein: the valve housing at least partially defines a plurality of fluid outlets including the first fluid outlet, a plurality of exhaust outlets including the first exhaust outlet, and a plurality of fluid chambers each fluidly coupled with at least one of the plurality of fluid outlets and at least one of the plurality of exhaust outlets; and the diaphragm is disposed partially in each of the plurality of fluid chambers to successively fluidly couple fluid outlets of the plurality of fluid outlets with the first fluid inlet, and successively exhaust the plurality of fluid outlets.

A vehicle seat assembly, comprising: the fluid valve assembly of any preceding embodiment; and a plurality of fluid bladders each fluidly coupled with a respective fluid outlet of the plurality of fluid outlets for successive inflation and permanent deflation.

A fluid valve assembly for a seat comprising a fluid bladder, the fluid valve assembly comprising: a valve housing at least partially defining a fluid chamber, a fluid inlet, and a fluid outlet; a diaphragm disposed in the valve housing and configured to flex between a first position and a second position according to a fluid pressure difference between the fluid inlet and the fluid outlet; and a plate disposed in the valve housing and separating the fluid chamber into a first section and a second section, the plate defining a first fluid passage and a second fluid passage; wherein, in the first position, the diaphragm restricts fluid flow through the first fluid passage; in the second position, the diaphragm permits flow from the fluid inlet through the first fluid passage to the fluid outlet; and the second fluid passage is configured to permit a first flow rate in a first direction toward the fluid outlet and to permit a second flow rate in a second direction toward the fluid inlet that is less than the first flow rate.

The fluid valve assembly of any preceding claim, further comprising a porous material disposed in the second fluid passage.

An electronic controller configured to control operation of any preceding embodiment.

The electronic controller of any preceding embodiment, wherein controlling the operation includes controlling a fluid source to provide fluid to inflate a bladder and controlling to fluid source to stop providing fluid, and wherein valve assembly automatically deflates the bladder.

A non-transitory computer-readable storage medium having a computer program encoded thereon for controlling operation of any preceding embodiment.

The storage medium of any preceding embodiment, wherein controlling the operation includes controlling a fluid source to provide fluid to inflate a bladder and controlling to fluid source to stop providing fluid, and wherein valve assembly automatically deflates the bladder.

In examples, a controller (e.g., the electronic controller 36) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “in the illustrated example,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in the illustrated example,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A fluid valve assembly for a seat comprising a fluid bladder, the fluid valve assembly comprising:
a valve housing at least partially defining a first fluid inlet, a first fluid outlet, and a first exhaust outlet;
a diaphragm disposed at least partially in the valve housing and configured to flex between a first position and a second position according to a first fluid pressure difference between the first fluid inlet and the first fluid outlet;
wherein, in the first position, the diaphragm restricts fluid flow from the first fluid inlet to the first exhaust outlet and the first fluid outlet; and
in the second position, the diaphragm permits flow from the first fluid inlet to the first fluid outlet and restricts fluid flow from the first fluid outlet to the first exhaust outlet.

2. The fluid valve assembly of claim 1, wherein, in the first position, the first exhaust outlet and the first fluid outlet are fluidly coupled; and
in the second position of the diaphragm, the diaphragm restricts flow between the first fluid outlet and the first exhaust outlet.

3. The fluid valve assembly of claim 1, wherein the diaphragm comprises:
a flange fixedly coupled with the valve housing;
a body including a through aperture; and
a flexible arm extending between and connecting the flange and the body.

4. The fluid valve assembly of claim 3, wherein the fluid valve assembly comprises a spring disposed at least partially around the body and biasing the diaphragm toward the first position.

5. The fluid valve assembly of claim 4, wherein the valve housing defines a first exhaust port and a first bleed port; and
wherein the first bleed port is fluidly coupled with the first fluid outlet and the first exhaust outlet.

6. The fluid valve assembly of claim 3, wherein the valve housing defines a bleed channel provided via at least one of a recess, a protrusion, or increased surface roughness.

7. The fluid valve assembly of claim 6, wherein the bleed channel fluidly couples the first fluid outlet with the first exhaust outlet in the first position and the second position of the diaphragm.

8. The fluid valve assembly of claim 7, wherein the valve housing includes a contact surface;
in the second position, the diaphragm is in contact with the contact surface; and
the contact surface at least partially defines the bleed channel.

9. The fluid valve assembly of claim 1, wherein the fluid valve assembly is configured as a permanent deflate valve to facilitate deflation of the fluid bladder with the diaphragm in the first position.

10. The fluid valve assembly of claim 1, wherein the valve housing comprises a first housing member coupled with a second housing member;
the first housing member and the second housing member cooperate to at least partially define a first fluid chamber;
the diaphragm is disposed at least partially in the first fluid chamber;
in the first position, the diaphragm is in contact with a first contact surface of the first housing member such that fluid flow through the diaphragm is restricted; and
in the second position, the diaphragm is in contact with a second contact surface of the second housing member such that fluid flow to the first exhaust outlet is restricted.

11. The fluid valve assembly of claim 10, wherein the valve housing further defines a second fluid inlet, a second fluid outlet, and a second exhaust outlet;
the first housing member and the second housing member cooperate to define a second fluid chamber separate from the first fluid chamber;
the diaphragm includes a first arm and a first body disposed at least partially in the first fluid chamber, and a second arm and a second body disposed at least partially in the second fluid chamber; and
the diaphragm is configured to flex between the second position and a third position according to a second fluid pressure difference between the second fluid inlet and the second fluid outlet, independent of the first fluid pressure difference.

12. The fluid valve assembly of claim 11, wherein the diaphragm is a monolithic component.

13. The fluid valve assembly of claim 1, wherein:
the valve housing comprises a first housing member coupled with a second housing member;
the first housing member and the second housing member cooperate to at least partially define a first fluid chamber and a second fluid chamber;
the diaphragm includes a first body disposed at least partially in the first fluid chamber and a second body disposed at least partially in the second fluid chamber;
the first fluid chamber includes a first section and a second section separated by the diaphragm;
in the first position of the diaphragm, the second section of the first fluid chamber is fluidly coupled with the first fluid outlet;
the valve housing defines a second fluid outlet;
in the first position of the diaphragm, the second fluid chamber is fluidly coupled with the second fluid outlet; and
in the second position of the diaphragm, the first fluid outlet is fluidly coupled with the first fluid inlet, and the second fluid chamber is fluidly coupled with the first fluid outlet.

14. The fluid valve assembly of claim 13, wherein, in the first position of the diaphragm, the first body and the second body are in disposed in default configurations;
in the second position of the diaphragm, the first body is in an extended position and the second body is in disposed in the default configuration; and
in a third position of the diaphragm, the second body is disposed in the extended configuration to fluidly couple the second fluid outlet with the first fluid inlet via a through aperture of the first body and the first fluid outlet.

15. The fluid valve assembly of claim 14, wherein, in the first position of the diaphragm, the first fluid outlet and a first section of the second fluid chamber are fluidly coupled with the first exhaust outlet.

16. A vehicle seat assembly, comprising:
the fluid valve assembly of claim 1; and
the fluid bladder fluidly coupled with the first fluid outlet.

17. The fluid valve assembly of claim 1, wherein:
the valve housing at least partially defines a plurality of fluid outlets including the first fluid outlet, a plurality of exhaust outlets including the first exhaust outlet, and a plurality of fluid chambers each fluidly coupled with at least one of the plurality of fluid outlets and at least one of the plurality of exhaust outlets; and
the diaphragm is disposed partially in each of the plurality of fluid chambers to successively fluidly couple fluid outlets of the plurality of fluid outlets with the first fluid inlet, and successively exhaust the plurality of fluid outlets.

18. A vehicle seat assembly, comprising:
the fluid valve assembly of claim 17; and
a plurality of fluid bladders each fluidly coupled with a respective fluid outlet of the plurality of fluid outlets for successive inflation and permanent deflation.

19. A fluid valve assembly for a seat comprising a fluid bladder, the fluid valve assembly comprising:
a valve housing at least partially defining a fluid chamber, a fluid inlet, and a fluid outlet;
a diaphragm disposed in the valve housing and configured to flex between a first position and a second position according to a fluid pressure difference between the fluid inlet and the fluid outlet; and
a plate disposed in the valve housing and separating the fluid chamber into a first section and a second section, the plate defining a first fluid passage and a second fluid passage;
wherein, in the first position, the diaphragm restricts fluid flow through the first fluid passage;
in the second position, the diaphragm permits flow from the fluid inlet through the first fluid passage to the fluid outlet; and
the second fluid passage is configured to permit a first flow rate in a first direction toward the fluid outlet and to permit a second flow rate in a second direction toward the fluid inlet that is less than the first flow rate.

20. The fluid valve assembly of claim 19, further comprising a porous material disposed in the second fluid passage.
